(19) United States
(12) Patent Application Publication
(10) Pub. No.: US 2015/0261264 A1
(43) Pub. Date: Sep. 17, 2015

(54) TOUCH INTERFACE DEVICE AND DESIGN

(71) Applicant: CANATU OY, Helsinki (FI)

(72) Inventors: David P. Brown, Helsinki (FI); Ilkka Varjos, Espoo (FI); Bjørn Friöur Mikladal, Helsinki (FI); Mikko Kärkkäinen, Helsinki (FI)

(21) Appl. No.: 14/434,005

(22) PCT Filed: Oct. 7, 2013
(86) PCT No.: PCT/FI2013/050972

§ 371 Date: Apr. 7, 2015

(30) Foreign Application Priority Data
Oct. 8, 2012 (FI) 20120340

(51) Int. Cl. G06F 1/16; G06F 3/041; G06F 3/044

(52) U.S. Cl. CPC G06F 1/1692; G06F 3/044; G06F 3/0416; G06F 1/1628

(57) ABSTRACT

The present invention discloses a touch interface device for numerous applications and also a principle to store the device in a compact form. The device includes a flexible touch sensitive film which can be enclosed into a casing when stored, and removed, either fully or partially, from the casing when in use. The film may be manufactured by using High Aspect Ratio Molecular Structures. Touch Driving, Sensing and Communication Modules, separate or combined, can be attached to the touch sensitive film in order to transmit a raw touch signal to Touch Processing and Communication Modules, either separate or combined, and then as further processed, to a desired CPU or computer. The casing may also house an internal projector for displaying information. Furthermore, haptic feedback can be generated via the touch sensitive film as well.

### FIELD OF THE INVENTION

The present invention relates to user interface devices, more particularly to user interface devices having touch sensitive films, and to uses and designs of such interface devices.

### BACKGROUND OF THE INVENTION

User interfaces for different kinds of electrical apparatuses are nowadays more and more often made with different types of touch sensing devices based on touch sensitive films instead of conventional mechanical buttons. Well known examples include different kinds of touch pads and touch screens in mobile phones, portable computers and similar devices. In addition to the sophisticated and even luxurious user experience achievable, user interface devices based on touch sensitive films also provide a superior freedom to the designers continuously trying to find functionally more versatile, smaller, cheaper, lighter, and also visually more attractive devices.

Portability and adaptability are key elements in such interfaces, and engineers and designers have sought means to achieve these via, for instance, touch pads, touch screens, pointer “mice” and keyboards. In general, these have been limited to rigid devices and, in the case of keyboards, they are not modifiable or they are minimally modifiable (e.g., the definition of each fixed key can be changed via software).

In touch sensing devices, a touch sensitive film is typically used comprising one or more conductive layers configured to serve as one or more sensing electrodes. The general operating principle of this kind of film is that the touch of a user by, e.g. a fingertip or some particular pointer device is detected by means of certain measuring circuitry to which the touch sensitive film is connected. The actual measuring principle can be e.g. resistive, inductive or capacitive, the latter one being nowadays usually considered the most advanced alternative providing the best performance in the most demanding applications. Other optical methods, such as Frustrated Total Internal Reflection (FTIR), which uses sources and detectors for electromagnetic radiation, are also known in the art.

Capacitive touch sensing is based on the principle that a touch on a touch sensitive film means, from electrical point of view, coupling an external capacitance to the measurement circuitry to which the touch sensitive film is connected. With sufficiently high sensitivity of the touch sensitive film, even no direct contact on the touch sensitive film is necessitated but a capacitive coupling can be achieved by only bringing a suitable object to the proximity of the touch sensitive film. The capacitive coupling is detected in the change of signals of the measurement circuitry. In a so-called projected capacitive method, the measurement circuitry includes drive electrodes and sense electrodes used for supplying the signal and sensing the capacitive coupling, respectively. This circuitry is also arranged to rapidly scan over the sensing electrodes sequentially so that coupling between each supplying/measuring electrode pair is measured.

Common for the known touch sensitive films in the projected capacitive method is that the need to properly determine the location of the touch necessitates a high number of separate sensing electrodes in the conductive layers. In other words, the conductive layers may be patterned into a network of separate sensing electrodes. The more accurate resolution is desired, the more complex sensing electrode configuration is needed. One particularly challenging issue is the detection of multiple simultaneous touches which, on the other hand, often is one of the most desired properties of the state-of-the-art touch sensing devices. Complex sensing electrode configurations and high numbers of single sensing electrode elements complicate the manufacturing process as well as the measurement electronics of the touch sensing device.

In touch screens, in addition to the touch sensing capability, the touch sensitive film must be optically transparent to enable use of the film in or on top of a display of an electronic device, i.e. to enable the display of the device to be seen through the touch sensitive film. Moreover, transparency is also very important from the touch sensitive film visibility point of view. Visibility of the touch sensitive film to the user of e.g. an LCD (Liquid Crystal Display), an OLED (Organic Light Emitting Diode) display, or an e-paper (electronic paper) display seriously deteriorates the user experience. So far, transparent conductive oxides like ITO (Indium Tin Oxide) have formed the most common group of the conductive layer materials in touch sensitive films. However, from the visibility, robustness, flexibility and cost points of view, they are far from an ideal solution. Other transparent conductive media are presently coming to the fore such as Carbon Nanotubes (CNTs), metal or metal composite Nanowires, conductive polymers, graphene and Carbon NANOBUDs.

One promising new approach in touch sensitive films is found in layers formed of or comprising networked nanostructures. In addition to a suitable conductivity performance, a layer consisting of networks of e.g. carbon nanotubes, or carbon NANOBUDs having fullerene or fullerene-like molecules covalently bonded to the side of a tubular carbon molecule, can be made less visible to a human eye than e.g. transparent conductive oxides like ITO, ATO or FTO. Besides, as is well known, nanostructure-based layers can possess flexibility, mechanical strength and stability superior in comparison with e.g. transparent conductive oxides.

Flexible keyboards based on alternative principles have been disclosed. In EP 0619894 (“Kikinis”), a flexible keyboard for computers is disclosed. The keyboard material is flexible, together with the keys. The keyboard can be rolled into a cylinder for storage and unrolled for the actual use. There are two layers where the first layer include the keys and the second layer senses the pressing of the key through electronically conductivity changes in the structure. The two layers are joined by joining means, allowing some relative motion between the two layers.

In U.S. Pat. No. 7,196,692 (“Mochizuki et al.”), a foldable keyboard and a flexible display is disclosed. As can be seen in e.g. FIG. 5, the keyboard is rotatable around a hinge-type of connection and the keyboard has thus two rigid sections. The flexible display is implemented as a color organic electroluminescence display sheet formed on a flexible plastic base film. The flexible display can be housed in a rolled state.

Document WO2008/150600 discloses a method and apparatus for an electronic interactive device having a haptic enabled flexible touch sensitive surface. The document further discloses the electronic interactive device including a flexible touch sensitive surface, a flexible screen, and an actuator. The flexible touch sensitive surface is deposited over the flexible screen and is capable of receiving an input from a user.

Document WO2003/050963 discloses interactive, low power, collapsible, intelligent, multi-media display systems for use as hand-held, portable communications devices. The display communications device can include a housing that contains a processor, radio transceiver means for transmitting and receiving radio signals, and a collapsible display that is mechanically coupled to the housing and electrically coupled to the processor.

Document US2007211036 discloses a method for providing interactive self-supporting screen with scalable flexibility.

Document US2007164980 discloses an apparatus for displaying images on a remote bistable reflective cholesteric display, comprising a portable electronic communications device comprising means for receiving signals corresponding to image information; a remote display device and means for receiving said signals transmitted to said remote location, and addressing means for producing images on said display.

Document US2011305493 discloses flexible touch-type keyboard includes a flexible keyboard module, a receiving assembly for receiving the flexible keyboard module, and a cover.

Document US2011227822 discloses an electronic input device comprising a flexible input means for receiving user input, a housing defining a space for accommodating said input means. The input device has a first state and the second state, and the input means adopts a compacted spatial configuration in the first state and an extended spatial configuration in the second state.

Document US2011063195 discloses a device comprising a flexible unit displaying visuals, sensing means for sensing distortions of said flexible unit an operable unit. An input may be registered by sensing a distortion of the flexible unit by the sensing means said distortion being caused by operating the operable unit.

Document US2011063195 discloses a soft display panel composed of a transparent substrate layer, a soft circuit layer and a display layer, a controller having a signal transmission device connected to the soft circuit layer, an input control device or making the soft circuit layer generate signals corresponding characters or drawings and a computer equipment having a computer application intercede connected to the signal transmission device.

Document US2002134828 discloses a data input device suitable for inputting data to electronic processing means. The data input device is configured to produce an output in response to a mechanical interaction and may be configured into two operational configurations, the first being flexible configuration and the second being rigid configuration.

Document US2003044216 discloses a membrane keyboard, comprising a bottom layer, a second conductive membrane layer located above the bottom layer having an output section extended from one end thereof at a selected location linking to an interrupt device, an insulation layer located above the second conductive membrane layer, a first conductive membrane layer located above the insulation layer, a top layer located above the first conductive membrane layer having a jutting section formed at one end with the top layer bonding to the bottom layer and forming an opening end at the jutting section, and a button key layer located between the first conductive membrane layer and the top layer.

To date, no user interface device capable of having a full use size and a sufficiently small storage size, so as to be pocketable, is available.

To summarize, none of these solutions provide a compact user interface device that can be stored and transported in a small size and then expanded to a significantly larger size for use.

### PURPOSE OF THE INVENTION

The purpose of the present invention is to provide a touch-technology based accessory for acting as the user interface of e.g. smartphones or tablet computers where the accessory can be stored in a small casing and carried easily in a compact storage mode, while providing an efficient and flexible input tool usable practically on any given surface when in a use mode.

### SUMMARY OF THE INVENTION

The first aspect of the present invention is focused on a user interface device (2), comprising: a flexible, formable and/or bendable touch sensitive film (1); a case (3) into which the touch sensitive film (1) can be stored, the case (3) having necessary electronics, including means for sensing touches on the touch sensitive film, power supply and means for transmitting via, e.g. a physical (ohmic), capacitive, inductive or wireless coupling, information from the touch interface device to a CPU (Central Processing Unit) or computer (12) such as a mainframe, desktop, laptop, notebook, tablet or smartphone, and thereby transmitting information on the properties of the touch, such as location, speed, direction, rotation, area or pressure.

A user interface device (2) is to be understood here broadly to cover all user interface devices operated by touching the device by an external object, as well as other types of devices for detecting the presence, proximity and/or location of such objects.

A user interface means, in general, any means for a user to transmit and or receive information, e.g. touch location, touch area, commands or elements of commands or status, to a device such as a computer. The goal of interaction between a user and a machine at the user interface is the effective operation and control of the machine, and possibly feedback from the machine which aids the operator in making operational decisions. Examples comprise, for instance, interaction between users and computer operating systems, hand tools, heavy machinery operator controls, musical instruments, and process controls.

The user interface includes hardware (physical) and software (logical) components. User interfaces exist for various systems, and provide means of input, allowing the users to manipulate a system and, in certain instances, may provide means of output, allowing the system to indicate the effects of the users' manipulation.

A CPU or computer (12) means, in general, a general purpose device that can be programmed to carry out a finite set of arithmetic or logical operations. Conventionally, a computer consists of at least one processing element and may include some form of memory for storing information. The processing element carries out arithmetic and logic operations, and a sequencing and control unit which can change the order of operations. These operations may be based on the stored information.

The touch sensitive film (1) of the present invention is capable of sensing one or more of the location, speed, direction, rotation, area, pressure etc. of one or more touches or the average or other property of said touch or touches. This comprises, for instance, gestures such as tap, pinch or rotate.

The word “touch” and derivatives thereof are used in the context of the present invention in a broad sense covering not only a direct mechanical or physical contact between the fingertip, stylus, or some other pointer or object and the touch sensitive film, but also situations where such an object is in the proximity of the touch sensitive film so that the object generates sufficient capacitive, inductive or other coupling between the touch sensitive film and the ambient, or between different points of the touch sensitive film. In this sense, the touch sensitive film of the present invention can also be used as a proximity or spacial gesture sensor.

By “conductive material” is meant here any material capable of allowing flow of electric charge in the material, irrespective of the conductivity mechanism or conductivity type of the material. Thus, conductive material covers here, for instance, also semiconductive or semiconducting materials. There can be one or more layers of conductive material in a touch sensitive film.

In addition to the conductive material, the touch sensing device can also comprise other layers of material and structures needed to implement an entire working touch sensitive element. For example, there can be one or more layers for mechanical protection of the film. Moreover, there can be also one or more layers for refractive index or color matching, and/or one or more coatings, for instance, for anti-scratch, decorative, water-repellant, self-cleaning, or other purposes. Besides the layered elements, the touch sensitive film can also comprise three-dimensionally organized structures, e.g. contact structures extending through the touch sensitive film or a portion thereof. The touch sensitive film can be transparent, semitransparent or opaque. The touch sensitive film can be rigid, semi-rigid, flexible, formable, bendable or foldable. The touch sensitive film can comprise polymers (such as PET, PEN, PVC, or Acrylic), glass, paper, rubber, fabric or leather.

By an “external object” is meant any capacitor or inductor or capacitive or inductive pointer, e.g. a human finger or a metal stylus, pointers having a capacitive element or a metallic coil for inductive coupling etc.

The electrical circuitry according to this embodiment is resistively, by radio waves, inductively or capacitively coupled to the touch sensitive film at one or more locations. The circuitry can comprise different types of contact electrodes, wirings and other forms of conductors, switches, and other elements needed to connect the touch sensitive film and the one or more conductive layers thereof to the rest of the user interface device. Resistive connection implies physical contact, while radio wave, inductive or capacitive coupling relates to wireless contact. Examples of resistive coupling include but are not limited to soldering, brushes, clamps or other traditional techniques.

The electrical circuitry is configured to supply one or more excitation signals to the touch sensitive film, and to receive one or more response signals from the touch sensitive film. The electrical circuitry is connected to a processing unit. In an exemplary embodiment of the invention, the signals are sent to the touch sensing film and received from it by the processing unit via the electrical circuitry. As it is clear to a skilled person, in practice, electrical circuitry together with processing unit may be partly or fully integrated to a single chip and thus, they may not be strictly separate.

An excitation signal means here any electrical signal, e.g. a pulsed, rise and fall time limited or oscillating voltage or current, supplied to the signal filter of the touch sensitive film via the circuitry and providing conditions suitable for monitoring the changes a touch induces in the filter properties. The excitation signal could also be called, for example, a drive signal or a stimulation signal. Typical examples are AC current and/or voltage. A response signal is, correspondingly, any measured electrical signal received from the signal filter by using the circuitry means and allowing detection of a touch on the basis of changes the touch causes to the filter properties and detectable by this signal. The response signal could also be called, for example, a sense signal.

In this embodiment, the processing unit is resistively (ohmicly), by radio waves, inductively or capacitively coupled to the electrical circuitry. The processing unit is configured to detect for instance, the presence or proximity of a touch by the external object, the location of said touch, the capacitance or inductance of said touch, the pressure or area of said touch, the proximity of said touch, the velocity of said touch, the direction of said touch, the average of said touch, the relative distance between two or more said touches, the relative rotation of two or more said touches, the duration of said touch or a combination thereof by processing one or more response signals.

The processing unit may comprise a processor, a signal or pulse generator, a signal comparing unit, an interpretation unit, and other hardware and electronics as well as software tools necessary to process the response signals.

In an embodiment of the invention, the touch sensing device is capable of operating in a single-layer or multi-layer configuration utilizing one or more touch sensitive films, each film having one or more conductive layers.

According to an embodiment of the present invention, the user interface device comprises a touch sensing/sensitive film (1), touch sensing electronics, a casing (3), power supply, means of transmitting and/or receiving information to and/or from the user interface device and means for rolling and/or unrolling the touch sensitive film in order to make a transition between storage and use states of the device. In general, the storage state may be created by alternative means or in an alternative form factor of the film such as a folded or crumpled film placed inside the casing, according to one embodiment of the invention.

Here the means of transmitting and or receiving information means, for instance, physical (e.g. ohmic contact) or wireless (e.g. via electromagnetic radiation such as radio waves, microwaves, infrared radiation, visible light, ultraviolet radiation, X-rays and gamma rays, inductive or capacitive coupling or sound waves). A highly practicable means of transmitting and or receiving information is by using standard wireless means such as Bluetooth or a wireless USB.

In one embodiment, the touch sensitive film is formed as a flexible structure so as to allow bending thereof. A “flexible” structure means here a structure allowing bending, even repeatedly, in at least one direction. Furthermore, the touch sensitive film can be flexible in at least two different directions simultaneously (e.g. stretchable).

Instead of or in addition to the flexibility, the touch sensitive film can also be formed as a deformable structure so as to allow deforming thereof, e.g. by using thermoforming along or over a three-dimensional surface (e.g. formable).

Flexibility and/or deformability of the touch sensitive film in combination with the unique measurement features of the present invention open entirely novel possibilities to implement touch sensing devices. For example, a touch sensitive film serving as the user interface of a mobile device can be bent or formed to extend to the device edges so that the touch sensitive film can cover even the entire surface of the device. In a touch sensitive film covering different surfaces of a three-dimensional device, there can be several touch sensing regions for different purposes. One sensing region can cover the area of a display to form a touch screen.

Other sensing regions e.g. at the sides of the device can be configured to serve as a touch sensitive element replacing conventional mechanical buttons, e.g. the power button, or volume or brightness sliders or dials.

A good choice for flexible and/or deformable touch sensitive films is a conductive layer comprising one or more HARMS (High Aspect Ratio Molecular Structure) networks, as is described in more detail below. HARM structures and the networks thereof are inherently flexible, thus enabling the touch sensitive film to be made flexible, bendable and/or deformable.

In one useful application and embodiment, the touch sensitive film is made optically transparent. Thus, this enables using the touch sensitive film e.g. as part of a touch screen or as a unique user interface on a supporting surface allowing the supporting surface to be seen through the sensor or for a particular pattern to be seen through the film to guide the user in his/her operation. Optical transparency of the touch sensitive film means here that at least 10%, preferably at least 50% of the incident radiation from a direction substantially perpendicular to the plane of the film, at the frequency or wavelength range relevant in the application at issue, is penetrated through the film. In most touch sensing applications, this frequency or wavelength range is that of visible light.

For the optical transparency, the key is the conductive material of a touch sensitive film. The requirement of simultaneous electrical conductivity and optical transparency limits the number of possible materials. In this sense, HARMS networks form a good basis for an optically transparent touch sensitive film because the HARMS networks can provide a transparency superior to that of the transparent conductive oxides, for example.

In one embodiment, the touch sensitive film comprises a HARMS network, a conductive polymer, graphene, a ceramic, grids of metal such as silver or gold, or a metal oxide. By HARMS or HARM structures it is meant here electrically conductive structures with characteristic dimensions in nanometer scale, i.e. dimensions less than or equal to about 100 nanometers. Examples of these structures comprise carbon nanotubes (CNTs), carbon NANOBUDs (CNBs), metal nanowires, and carbon nanoribbons. In a HARMS network, a large number of these kinds of single structures, e.g. CNTs, are interconnected with each other. In other words, at a nanometer scale, the HARM structures do not form a truly continuous material, such as, e.g., the conductive polymers or Transparent Conductive Oxides, but rather a network of electrically interconnected molecules. However, as considered at a macroscopic scale, a HARMS network forms a solid, monolithic material. As a useful feature, HARMS networks can be produced in the form of a thin layer.

The advantages achievable by means of the HARMS network(s) in the sensitive film include excellent mechanical durability and high optical transmittance useful in applications requiring optically transparent touch sensitive films, but also very flexibly adjustable electrical properties. To maximize these advantages, the conductive material can substantially comprise one or more HARMS networks.

The resistivity performance of a HARMS network is dependent on the density (thickness) of the layer and, to some extent, also on the HARMS structural details like the length, thickness, or crystal orientation of the structures, the diameter of nanostructure bundles etc. These properties can be manipulated by proper selection of the HARMS manufacturing process and the parameters thereof. Suitable processes to produce conductive layers comprising carbon nanostructure networks with sheet resistances in the range according to the present invention are described e.g. in WO 2005/085130 A2 and WO 2007/101906 A1.

In one embodiment of the touch sensing device according to the present invention, the touch sensing device also serves as a haptic interface film. In other words, the device further comprises means for generating a haptic feedback, preferably via the sensitive film, in response to a touch. Providing the haptic feedback via the sensitive film means that, instead of the conventional approach based on separate actuators attached to the touch sensitive film for generating vibration of the touch sensitive film, the sensitive film is used as a part of the means for generating the haptic feedback. There are various possibilities for this. A haptic effect can be achieved by generating suitable electromagnetic field(s) by means of the sensitive film. The skin of the user touching the touch sensitive film senses these fields as different sensations. This kind of approach can be called capacitive haptic feedback system. On the other hand, the sensitive film can alternatively be used, for instance, as a part of an electroactive polymer (artificial muscle) based haptic interface, wherein the sensitive film forms one layer of the interface. Alternatively, the touch surface may be textured, dimpled, embossed or otherwise modified so as to have tactilely identifiable surface features that guide the user via the sensation of touch.

One possibility to perform both functions, i.e. the touch detection and the haptic feedback, is that the sensitive film is alternately coupled to a touch sensing circuitry and to means for producing the signals for haptic feedback so that, once a touch is detected during a first time period, a haptic feedback is then provided at a second time period following the first one. The first and second time periods can be adjusted to be so short that the user experiences the device operating continuously.

In one embodiment of the touch sensing device according to the present invention, the touch sensing device also serves as a deformation detecting film. This means that the device incorporates means for e.g. sensing bending, twisting and/or stretching of the sensing film. This can be done by measuring changes in the resistance between nodes or by changes in the signal filter properties simultaneously with the touch sensing according to the invention. As the signal filtering properties of the system are a function of the resistivity of the film and, at least for certain materials, including but not limited to HARMs and conductive polymers and in particular nanotubes and NANOBUDs and more specifically, carbon nanotubes and NANOBUDs, the signal filter properties can change if the film is e.g. stretched, compressed or otherwise deformed. By interpreting this change in either the resistivity or signal filter properties, the present invention can detect, for instance, elongation or compression between nodes connected to the sensing film. Thus, for example, sensing of elongation between two sets of nodes on opposite sides of the film indicates whether the sensor is in the storage state (e.g. rolled or folded) vs. the use state (e.g. unrolled or unfolded). Alternative configurations are also possible according to the invention.

For certain deformable external objects, the capacitance or inductance changes with the force applied to the touch sensitive film and thus the determined capacitance or inductance can be used as a proxy for force. The force means e.g. a force which a user applies to the film when performing a touch. A human finger, for instance, deforms upon the application of a force resulting in increased area in proximity to the sensor film. This will cause the capacitance to change accordingly. Alternatively, if an inductive external object is used, and the user deforms, for instance, a coil of the external object or changes the distance from the coil to the surface (e.g. via a spring), inductance changes and the force can be measured as well.

The user interface device of the present invention can be implemented as a standard or customized stand-alone module or as a non-separable unit integrated as a part of some larger device, e.g. a mobile phone, portable or tablet computer, e-reader, electronic navigator, gaming console, refrigerator, blender, dishwasher, washing machine, coffee machine, stove, oven or other white goods surface, car dashboard or steering wheel, etc.

The setup may require supplemental electronics that handle the creation, sending and receiving of the data and the AC current that creates either electrostatic or electrodynamic induction between electrodes that are located on both the main device and the touch sensing module. These two devices may be wirelessly coupled together by one or more of the following methods:
Electromagnetic induction (inductive coupling, electrodynamic induction), where the data and power transmission is induced by current from a magnetic field between opposing coils.
Magnetic resonance is near field electromagnetic inductive coupling through magnetic fields.
Radio waves (e.g. RFID technology; Radio Frequency IDentification), wherein the power is generated from the radio waves received by the antenna, and the data transmission substantially changes the radiated field load.
Capacitive coupling (or electrostatic induction), wherein the energy and data are transferred from opposing planes of electrodes.

Today's touch sensors are fully or partly integrated to the application devices either by wires, directly soldered or via connectors. This is sufficient in fixed installations where the sensors typically are positioned in areas that are not required to be open apart. E.g. in portable devices they are typically found in touch display applications, wherein the display is actually beneath the touch sensing film and the screen itself is permanently attached to the device. If a touch sensing device was located on a removable part of a device, then it would require a connector by which it could connect to the device once it is attached to it. This method is functional but it may not be suitable in certain applications. Moreover, even if a touch component is intended to be permanently affixed to a device, there are manufacturing costs and design limitations associated with connecting the component via solder or connectors.

This invention solves the problem of providing 2- and 3-dimensional touch sensor devices to applications whose enclosure cover has to be removed, for example to maintain and change the serviceable parts inside or where separate parts of the device, e.g. the touch sensitive film, the power supply, the sensing and driving electronics and/or the CPU are separated via, for instance, rotating connections such as a rotating axel and bearing. It is also a robust method to provide data entry method to devices requiring unbroken encapsulation for, for example, wet, explosive or otherwise hazardous environments or where direct connection, as with interconnecting wires, is otherwise impossible, costly or highly inconvenient.

Additional benefits are that this method requires no physical connector for power and data transmission that is susceptible to dirt, wear and tear or breakage. With no connector, there are fewer parts susceptible to contamination, chemical or physical degradation or mechanical damage thus increasing the reliability of the device.

This invention does not need a direct physical contact which, if not secured firmly, may have an unintentional disconnection and thus lead to data or power loss. It may function as a remote control device to fixed installations that takes the power from the installation and works as an ad-hoc touch sensor or as a generic data input and output device.

A further benefit is that by keeping the certain functionalities in a module and separating it from other functions, they become different serviceable parts that can be produced separately and combined together only at the final assembly. An additional cost benefit is that an electrode is simply a metal area or a printed wire on a printed circuit board.

According to one embodiment of the present invention, the touch sensor module and the main device may be physically attached to each other but the power or data or both are transmitted wirelessly between them. In practice, the sensor, excitation and sensing electronics together with the data processing unit are arranged so that the whole unit is an independent peripheral plug-in unit.

The main advantage of the present invention is that, while some known keyboards claim to be modifiable between a full-sized use state and a compact storage state, it is not possible to achieve a sufficiently small storage state (e.g. in rolled, crumpled or folded form) to be essentially pocket-sized. The present invention introduces a truly mobile and pocketable touch-based accessory. It is based on a flexible touch sensor that allows the user to turn virtually any surface, soft or hard, flat or curved, into a full functionality user interface for a computer or mobile device such as a tablet or especially, a smartphone. This kind of operation further turns the smartphone into a portable and usable pocket computer. With the present invention and the smartphone, any surface can be effectively turned into a touch surface and any “dumb” object can be turned into a “smart” object.

Below, the present invention is described on the basis of examples with references to the accompanying drawings.

### BRIEF DESCRIPTION OF THE DRAWINGS

FIG. 1 illustrates examples of touch sensitive films usable according to the present invention.

FIGS. 2a, 2b, 2c, 2d and 2e illustrate examples of an embodiment of the invention in full or partial user mode, in storage/transportation mode, for a computer keyboard application, and in an exploded view.

FIG. 3 is an illustration a touch sensing film with a printed pattern on an opaque and on a transparent substrate.

FIG. 4 shows schematic diagrams of various embodiments of the invention.

FIG. 5 shows various printed patterns according to the invention.

FIGS. 6a and 6b show details of the touch sensing film with and without printed pattern according to the invention.

FIG. 7 shows various embodiments of the invention.

FIG. 8 shows various embodiments of the invention.

FIG. 9 shows various embodiments of the invention according to the implementation of the example of FIG. 4a and with the addition of a touch surface.

FIG. 10 shows the use of the present invention on various supporting surfaces.

FIG. 11 shows a resistive touch embodiment of the touch sensing film.

FIG. 12 shows means of reducing storing a resistive touch sensing film according to the invention.

### DETAILED DESCRIPTION OF THE INVENTION

An explanation of the main principles of the present invention follows based on the examples described below.

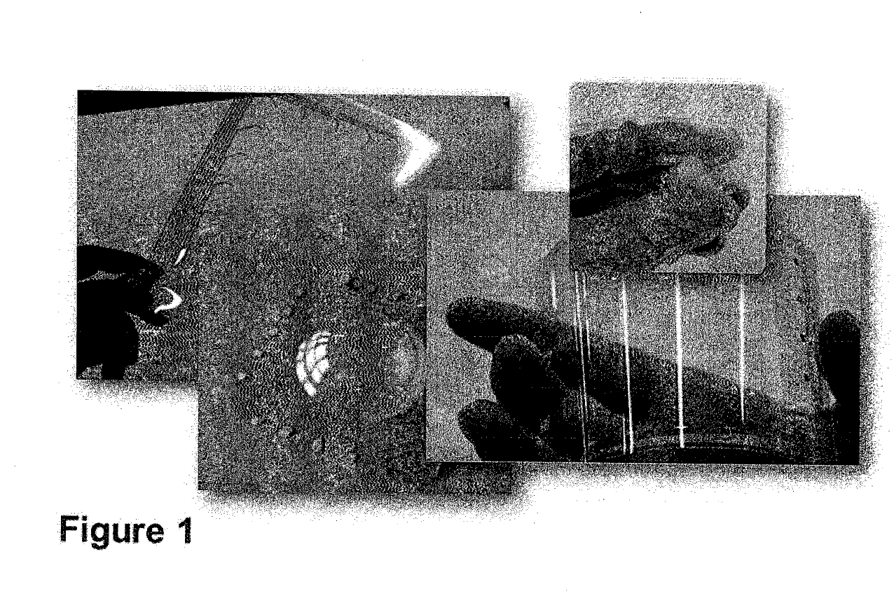

FIG. 1 shows various examples of touch sensing films that can be used according to the invention comprising a flexible, transparent PET (polyethylene terephthalate) substrate, flexible Carbon NANOBUD transparent electrode, silver traces to connect to driving and sensing circuitry and hard, anti-reflective and other coatings as needed. Other substrates, electrode materials, circuitry and coatings are possible according to the invention. Other touch sensing techniques are possible according to the invention including capacitive, inductive, resistive, optical and acoustic sensing. Substrates, electrodes and coatings can be transparent, semi-transparent or opaque according to the invention. The present invention does not limit the materials comprising the touch sensing film.

The touch sensing film can be coated or encapsulated so as to be dirt and water resistant and easily washable with soap, detergents, and solvents. Moreover, due to the ultra-thin, printed and flexible nature of the rollable electronics, the touch sensing film can be made extremely robust to resist, e.g., impact and compression.

The user interface device comprises at least a touch sensing film, means of sensing input to the touch sensing film and means of storing the touch sensing film in a reduced form factor such as in a rolled or folded state.

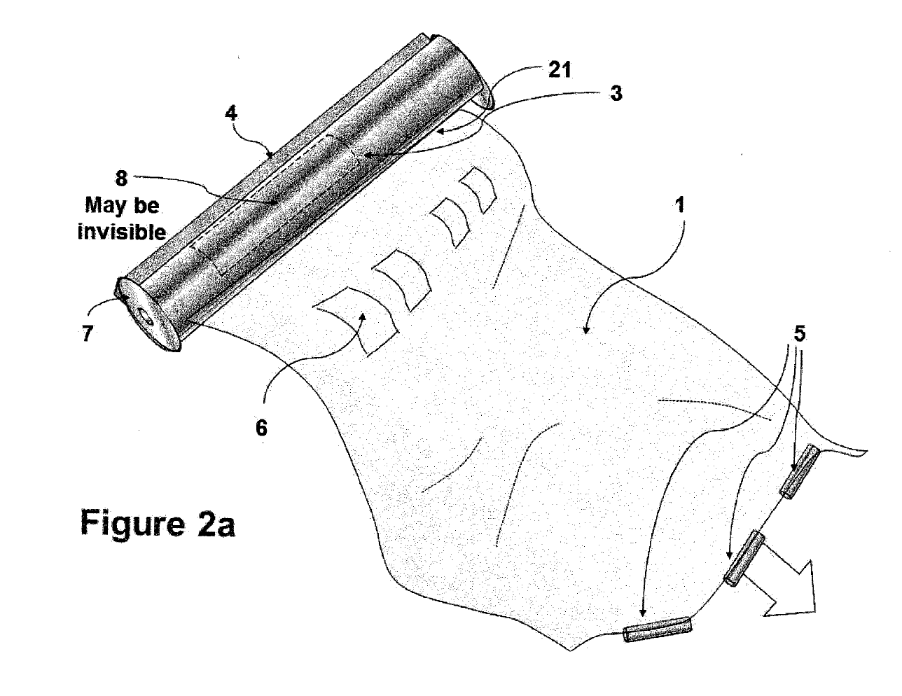

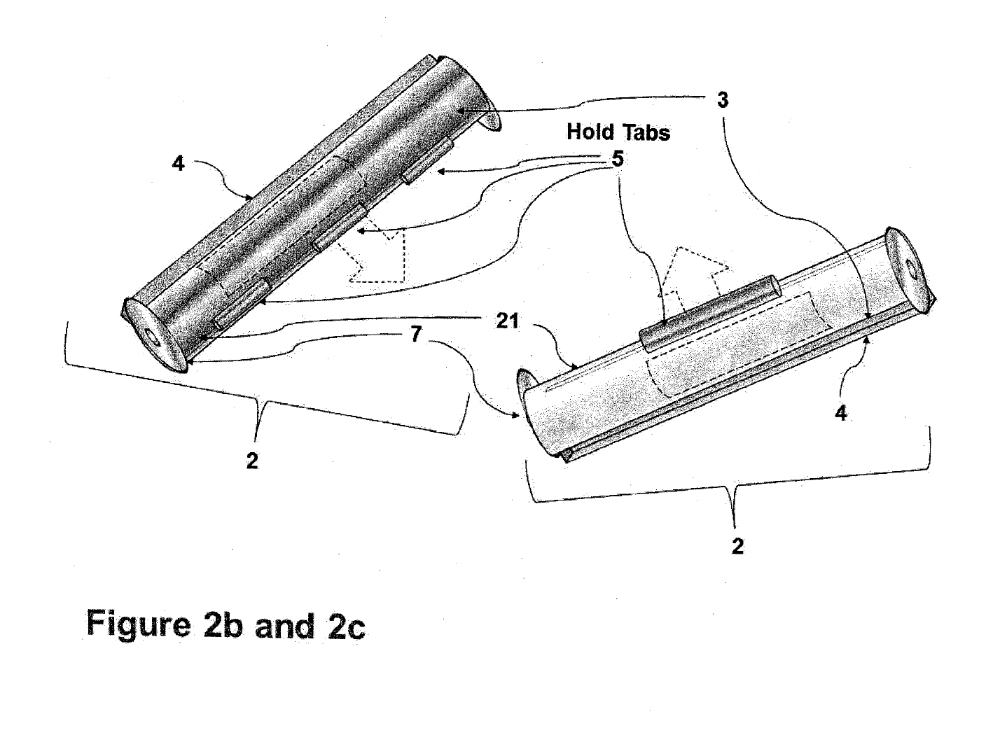

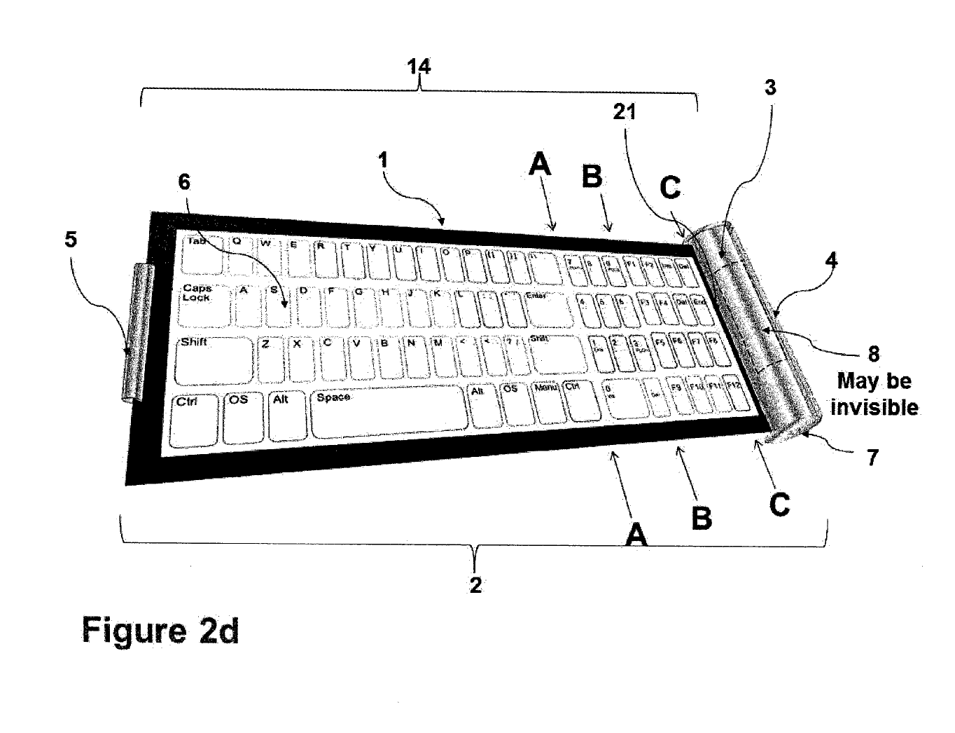

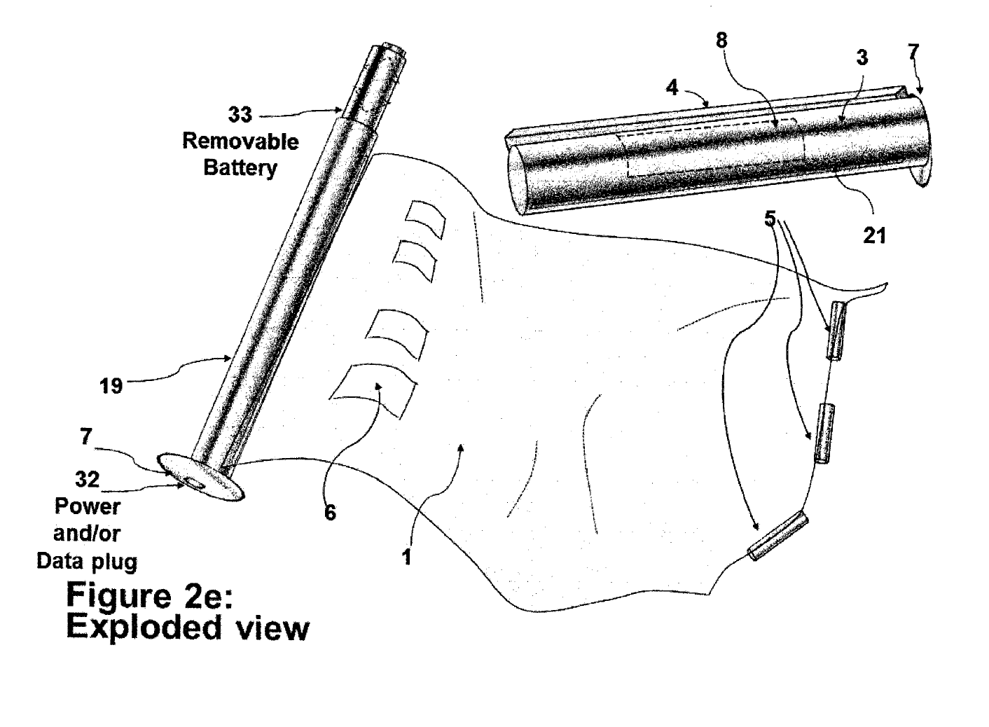

An embodiment of the present invention is shown in FIG. 2a in its full form factor or in the full use mode or state. In this embodiment, a case or casing (3) is used to assist in reducing the form factor of the touch sensing film (1), by aiding in the storage of the touch sensing film (1) and, by the use of a casing with a dispensing passage (21), facilitate the rolling of the touch sensing film (1) by both guiding the touch sensing film into the casing and by limiting the rolling of the touch sensing film (1) by means of a hold tab (5). One or more hold tabs (5) may be attached to the edge of the touch sensing film (1) for the user to grab and unroll the touch sensing film (1) and to prevent the touch sensing film (1) from completely rolling up into the casing (3) when converting the device to transportation and storage mode/state. Other means of rolling or otherwise reducing the form factor of a touch sensing film (1) and thus, the user input device (2) and/or of guiding the touch sensing film (1) and/or of limiting the motion, state or form factor of the stored touch sensing film (1), are possible according to the invention. The casing (3) may have a touch sensor based section (8), which may also be invisible, for using the section as a further touch pad and/or control button or slider e.g. for scrolling the information on the screen of the external device (see also the section later).

FIG. 2b shows an embodiment of the invention in its storage, transportation or protected mode or state where the touch sensing film (1) is in its fully rolled state as limited by the hold tabs (5), and which is also ready to be unrolled for use.

The casing (3) may enclose a power supply such as a battery or means of delivering external power, such as a power chord (not shown), electronics to drive and sense and interpret/process signals so as to detect touch, and means to transmit information from the user interface device (2) to a computer/CPU. Note that the term computer and CPU are here used interchangeably to mean the computation, graphics, and other components needed to interpret the output of the interface device (2) into a command and/or output according to, for instance, a computer program. Examples of CPU/computers are CPU circuits, mainframes, desktops, laptops, notebooks, tables, smartphones, smart watches or any other similar devices.

In an embodiment of the touch interface device (2), appropriate electronics to drive and sense touch on the touch sensing film (1) and touch surface (8), communication electronics to send and receive information such as touch location, force, area, speed, direction, rotation etc., power supplies and/or sources are incorporated in or on the casing (3). In the embodiment, all or part of said electronics are enclosed in an electronics box (4). In the embodiment, the casing (3) is largely cylindrically shaped to enclose the rolled touch sensing film (1) along the axel and it has an essentially rhomboid shaped enclosure (4) along one side which serves to hold the required electronics and communication components, acts as a handle to hold the device during rolling and unrolling and also acts as a stabilizer to prevent the user input device from rotating when in use or to keep the interface device (2) from rolling uncontrollably when not in use.

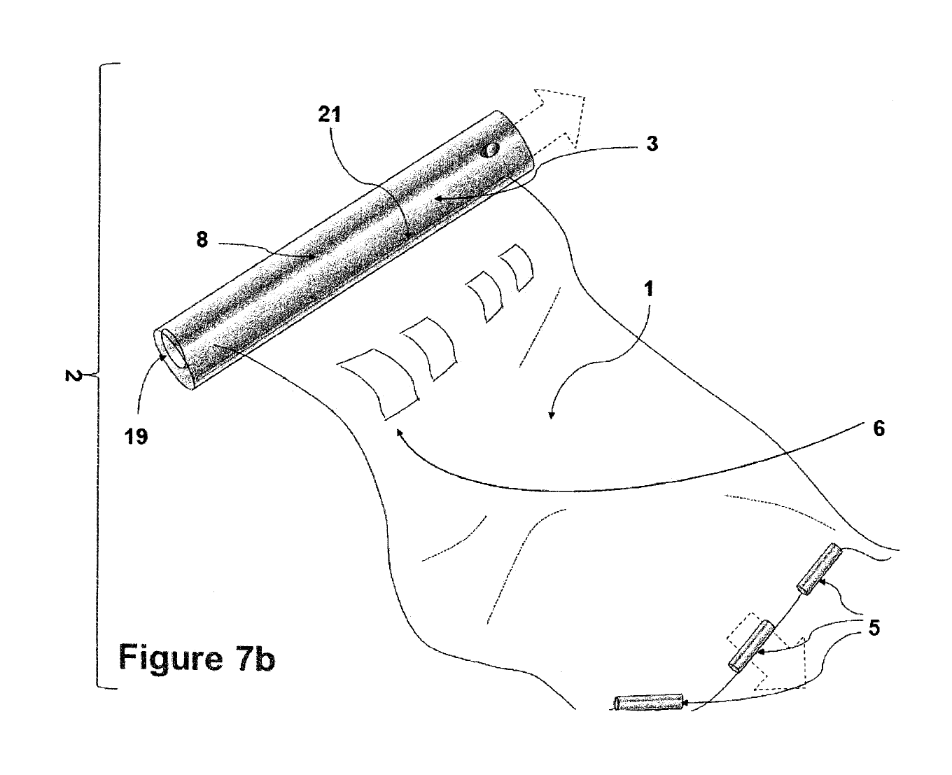

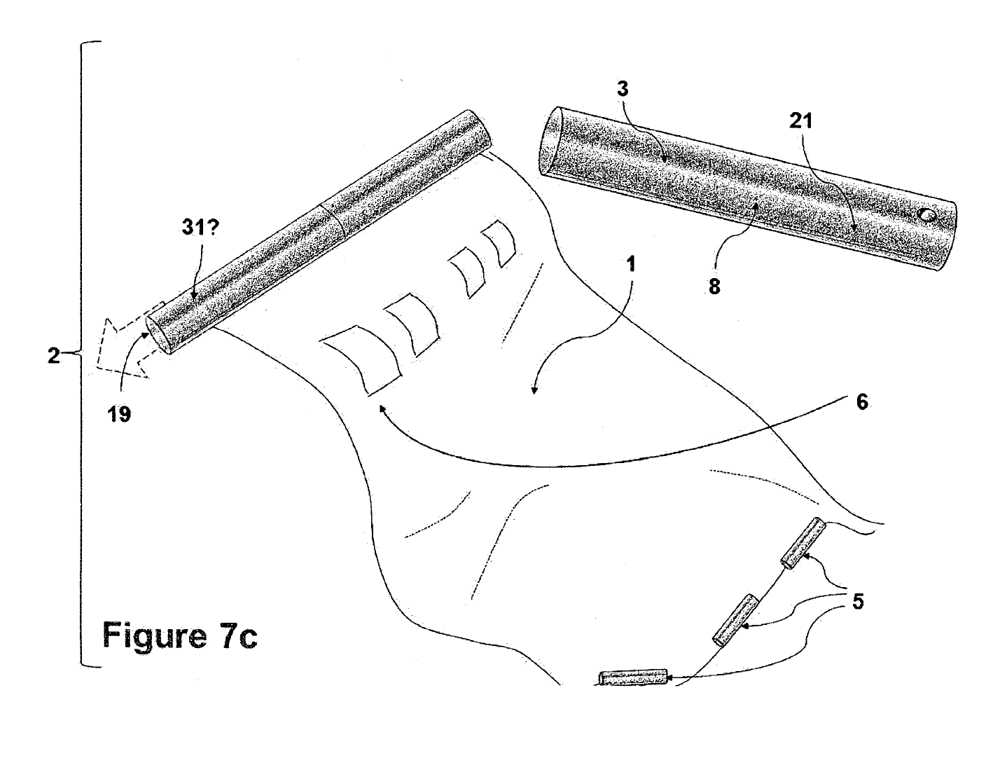

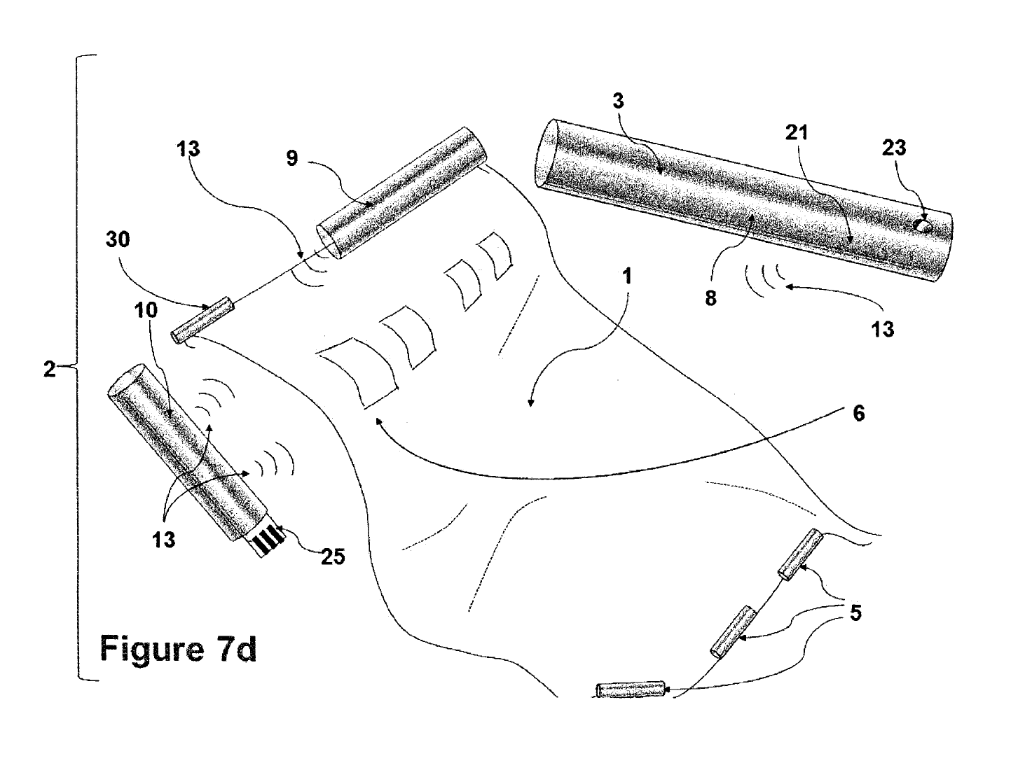

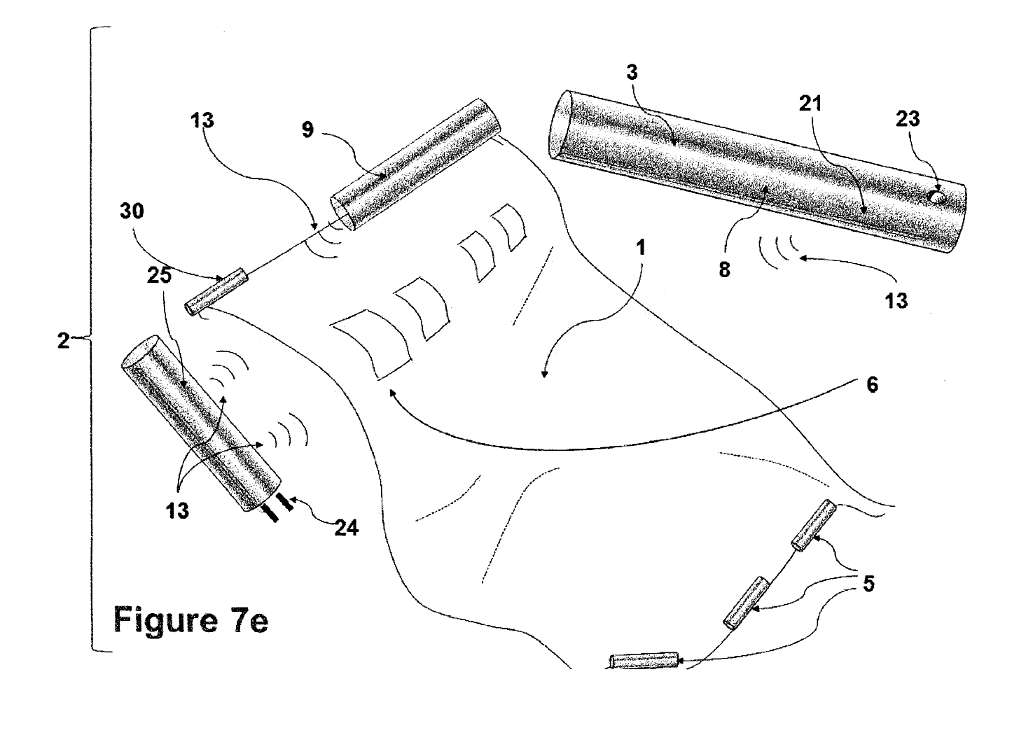

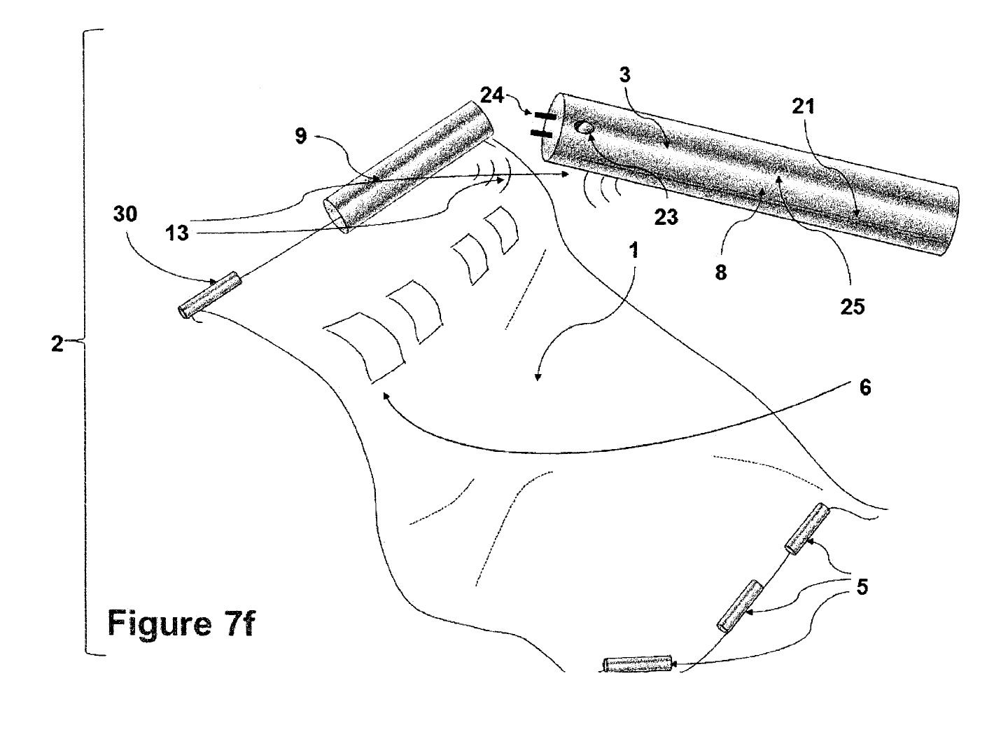

In the embodiment of the present invention of FIGS. 2a-2e, the touch sensing film is attached to a mechanism for rolling the film on an axel (19) (shown in FIG. 7), an example being a pair of rolling disks (7) attached to ends of the rolling axel (19) which is secured though a rolling or sliding bearing (not shown). The axel (19) can be rotated with respect to the case (3) by hand or by rolling on a surface such that the axel (19) rotates and retracts the touch sensing film (1), which is attached to the axel (19), into the case (3), which does not rotate due to being held by the user. Other mechanism such as springs, which are common in window shades, can be used to roll-up the touch sensing film (1) according to the invention.

A touch sensing film can be rolled out to various stages, for instance, in the computer keyboard (14) example of FIG. 2d, to the full keyboard, which has number and function keys (C-C) or to various less complete stages, e.g. (B-B) or (A-A) such that only the basic keys, such as letters, spaces and commands or other subsets of the full input are accessible. In such a situation, the non-accessible part of the keyboard is rolled into the case (3).

Preferably, the device is connected wirelessly to the computer via a standard protocol such as Bluetooth or wireless USB, but other means are possible including direct ohmic contact via a cable, or by radio, acoustical, electromagnetic (e.g. optical) or by any other means.

In an embodiment, all or part of the case (3) of the user input device can also incorporate a touch surface (8) which may act as a touchpad, scroll bar or pointer, allowing the user functions such as point, tap and scroll for easy surfing and/or graphical editing. Touch sensing techniques, which can be used in the touch sensing film, can be applied for the touch surface (8) as well according to the invention. In FIG. 2e, an exploded view of different parts of the device is shown. The touch sensing film (1) can be unrolled from the casing (3) and attached to the casing (3), there is an electronics box (4). In the end of touch sensing film (1) there are at least one hold tab (5). Furthermore, the touch sensing film may comprise printed patterns (6), e.g. patterns depicting letter buttons. Furthermore, at the end of the axel (19) of the device, there are rolling disks (7). As disclosed earlier, the outside surface of the casing may comprise one or more touch sensing technology based sections (8) which may act as a pointer and/or scroller tool for the user, for instance. A dispensing passage for the film to enter and to leave the casing is shown as (21). Furthermore, the rolling disk in the end of the axel (19) may be provided with a Power and/or Data plug (32) for providing supply and in/out data transfer from or to the user input device. Also, a removable battery (33) may be inserted inside the axel (19) structure in order to provide power to the user input device and to keep the device wireless at the same time.

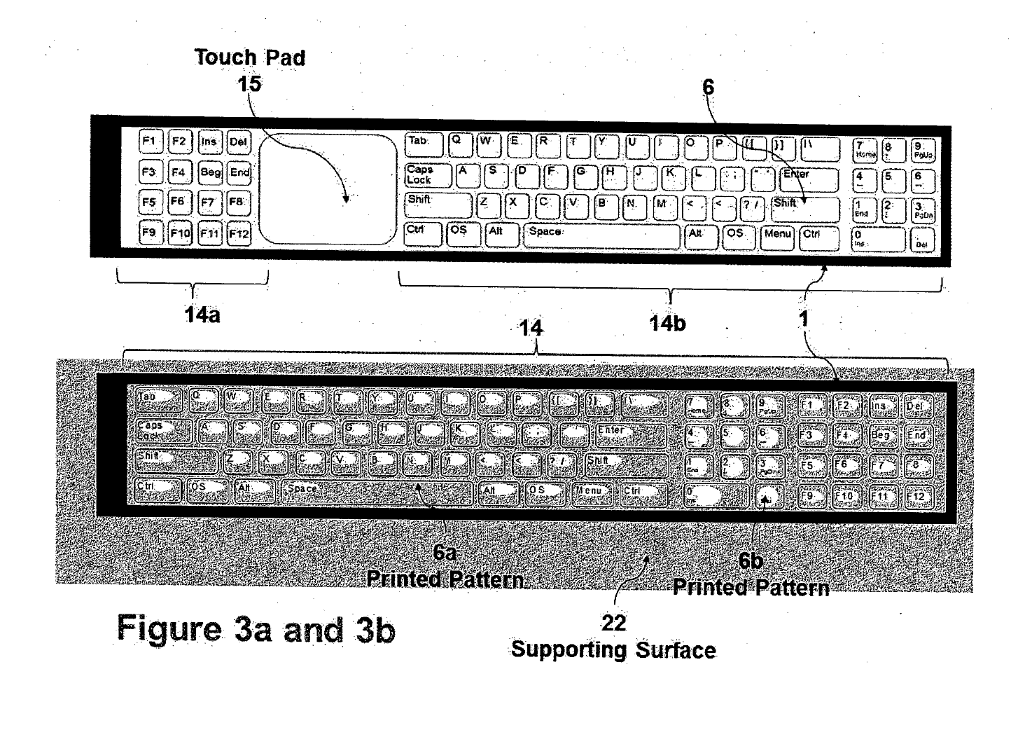

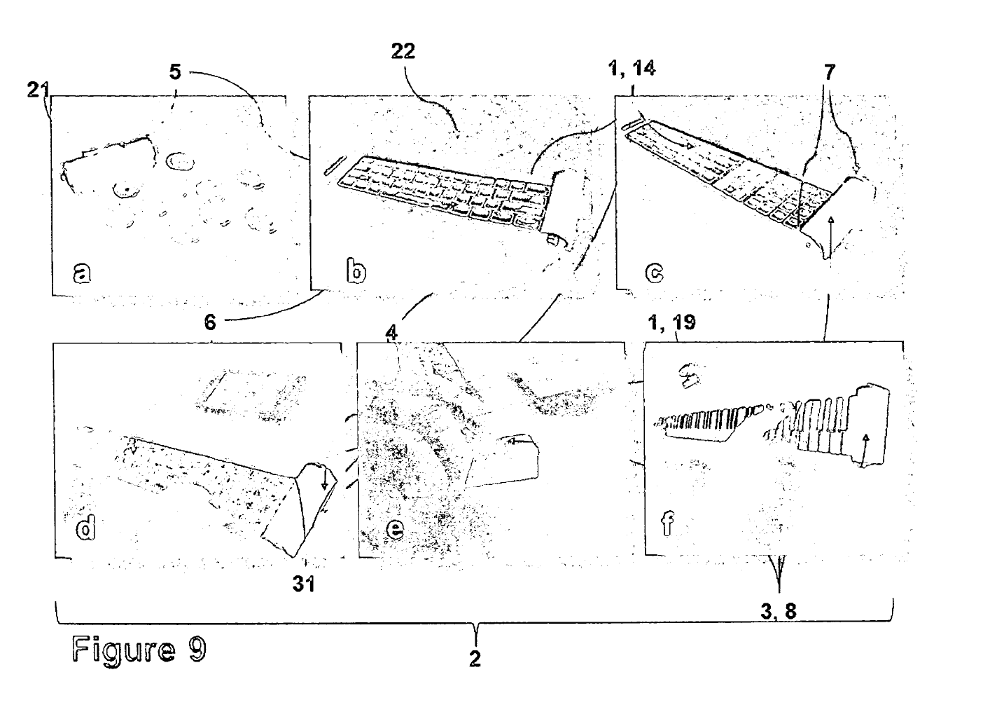

FIG. 3 is an illustration of a touch sensing film (1) with a printed pattern (6) on an opaque or semi-transparent (FIG. 3a) substrate and on a semi-transparent or transparent (FIG. 3b) substrate. In the case of an opaque or semi-transparent substrate, the background color can be the substrate color or another printed color (as in FIGS. 9d, 9e and 9f) and the printed pattern (6) can be a color having sufficient contrast to be visible against the background color. In the case of a semi-transparent or transparent substrate (FIG. 3b and FIGS. 9b and 9c), the background color becomes approximately the supporting surface (22) color. In order to assure that the printed pattern is visible on an arbitrary substrate, a local background or outline pattern (6b) can be printed beneath or around the main printed pattern (6a) so that sufficient contrast for visibility is assured on any supporting surface (22) or even without a supporting surface. For example, the main printed pattern (6a) can be printed in black while the local background or outline pattern (6b) can be printed in white.

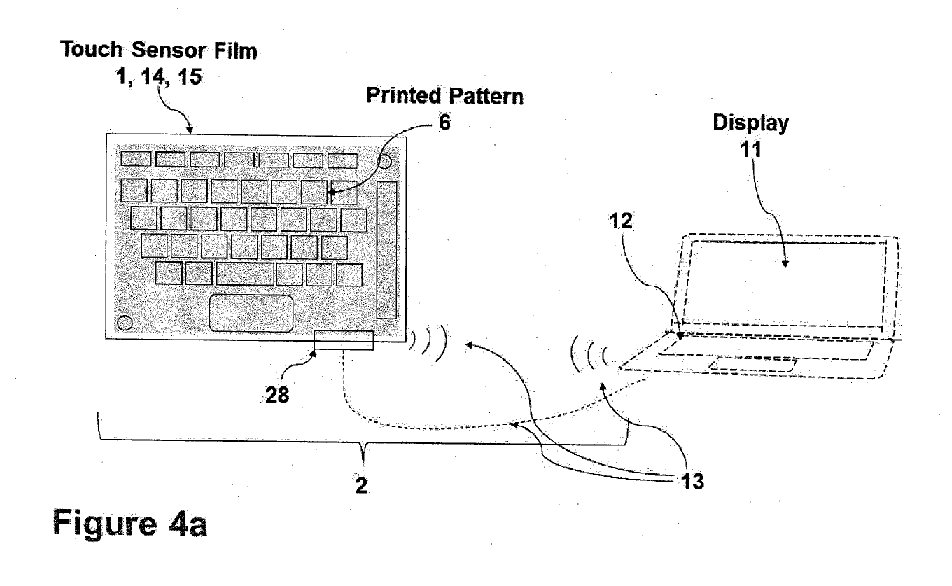

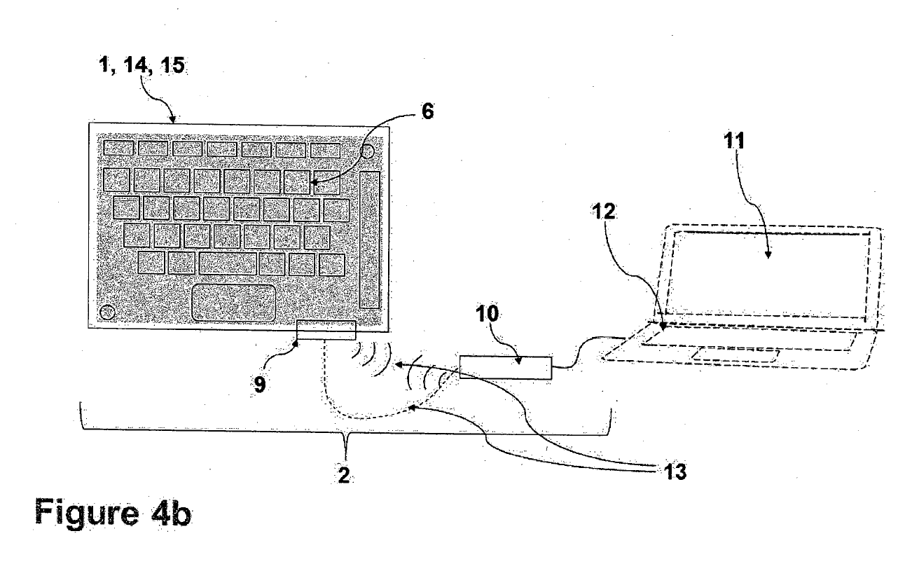

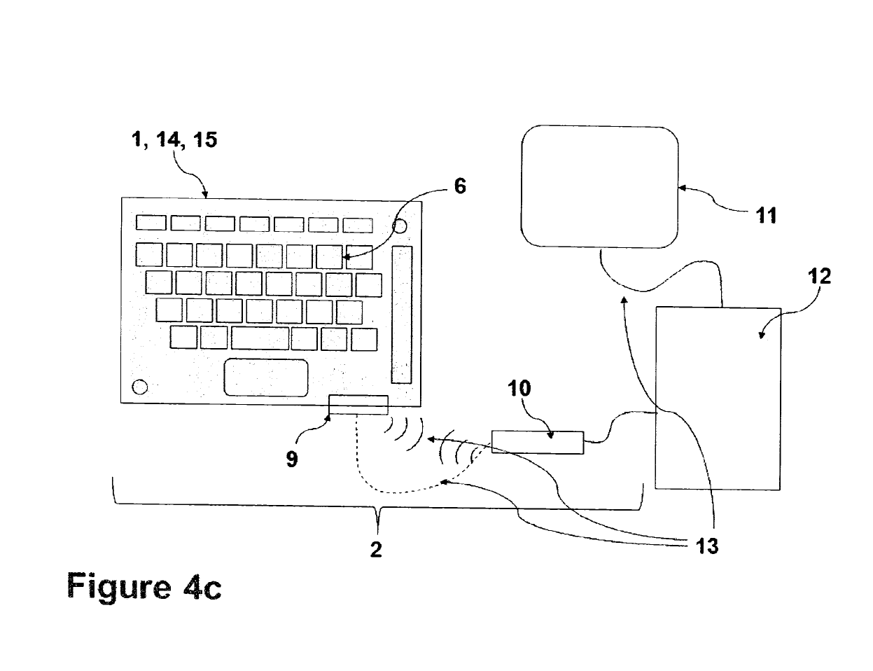

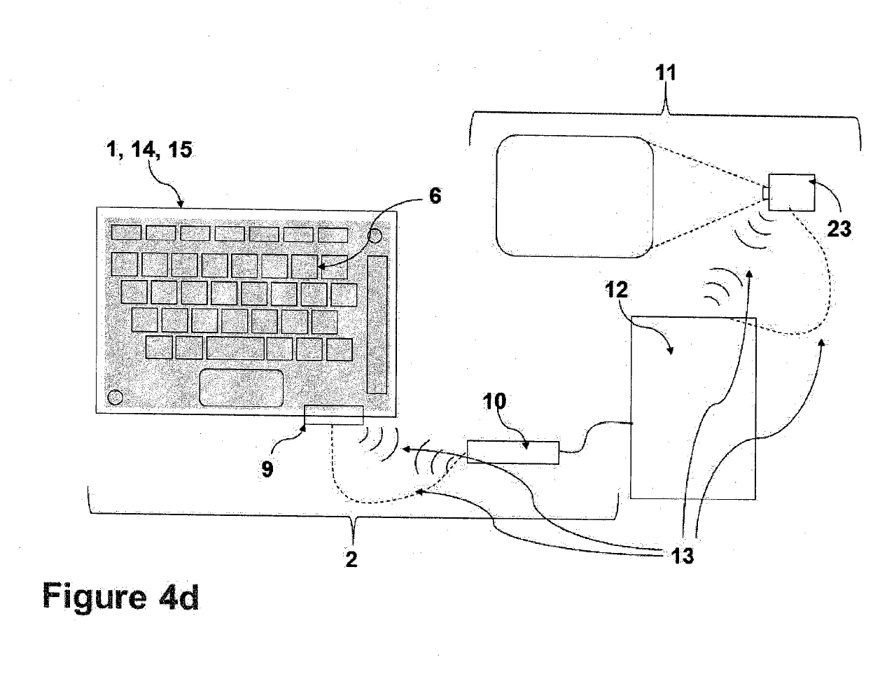

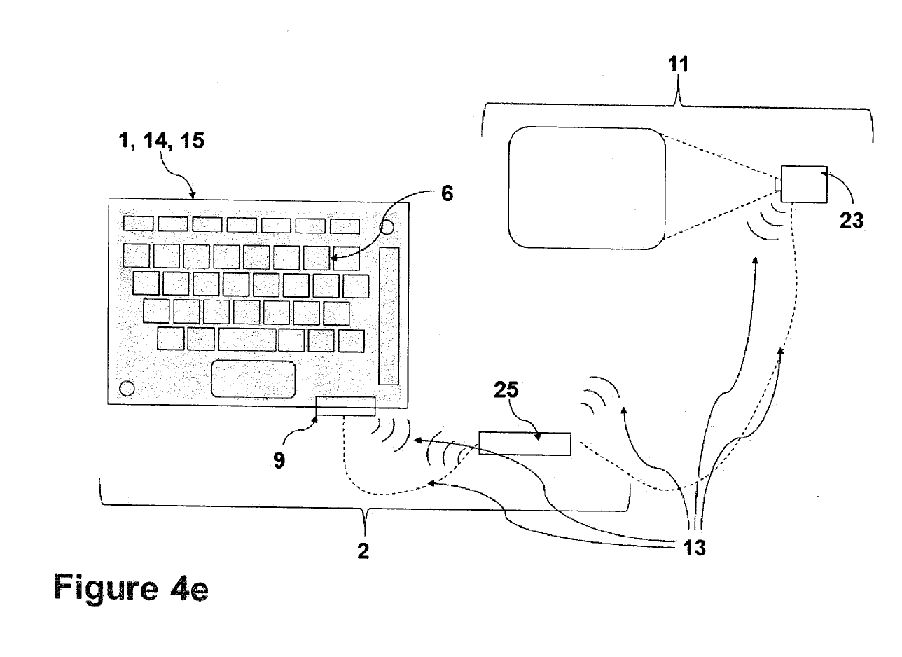

An embodiment of the invention as a schematic drawing is shown in FIG. 4a. Attached to the touch sensing film (1), which in this instance has a printed pattern (6) for a computer keyboard (14) and touch pad application (15) (or shortly, a touch pad app), is a Touch Driving, Sensing, Processing and Communication Module (28) which determines touch properties and sends the information to a CPU/computer (12) to be used during the operation of a resident program. Information is passed (13), for instance, ohmicly or wirelessly to, and possibly from, the CPU/computer (12) where it, or a consequence of it, can be displayed on the display (11). The consequence may be a result of an executed command or a pop-up window emerging after pressing a function key, for instance.

Other embodiments of the invention in schematic form are shown in FIGS. 4b, 4c and 4d. Attached to the touch sensing film (1), which in this instance has a printed pattern (6) for a computer keyboard (14) and touch pad app (15), is the Touch Driving, Sensing and Communication Module (9) which produces a raw touch signal which is then sent to a Touch Processing and Communication Module (10) to be interpreted as a touch with certain properties and then it is sent to a CPU/computer (12) to be used during the operation of a resident program. Information is passed (13), for instance, ohmicly or wirelessly between the Touch Driving, Sensing and Communication Module (9), Touch Processing and Communication Module (10) and the CPU/computer (12) where it, or a consequence of it, can be displayed on the integral display (11) (FIG. 4b), remote display (11) (FIG. 4c) or via a projector (23) display (11) (FIG. 4d).

Another embodiment of the invention in schematic is shown in FIG. 4e. Attached to the touch sensing film (1), which in this instance has a printed pattern (6) for a computer keyboard (14) and touch pad app (15), is the Touch Driving, Sensing and Communication Module (9) which produces a raw touch signal which is then sent to a CPU and Touch Processing and Communication Module (25) to be interpreted as a touch and used during the operation of a resident program. Information is passed (13), for instance, ohmicly or wirelessly between the Touch Driving, Sensing and Communication Module (9), CPU and Touch Processing and Communication Module (10) and the display (11).

Other combinations and distributions of the above referred hardware, software, functions, communication and processes are possible according to the invention.

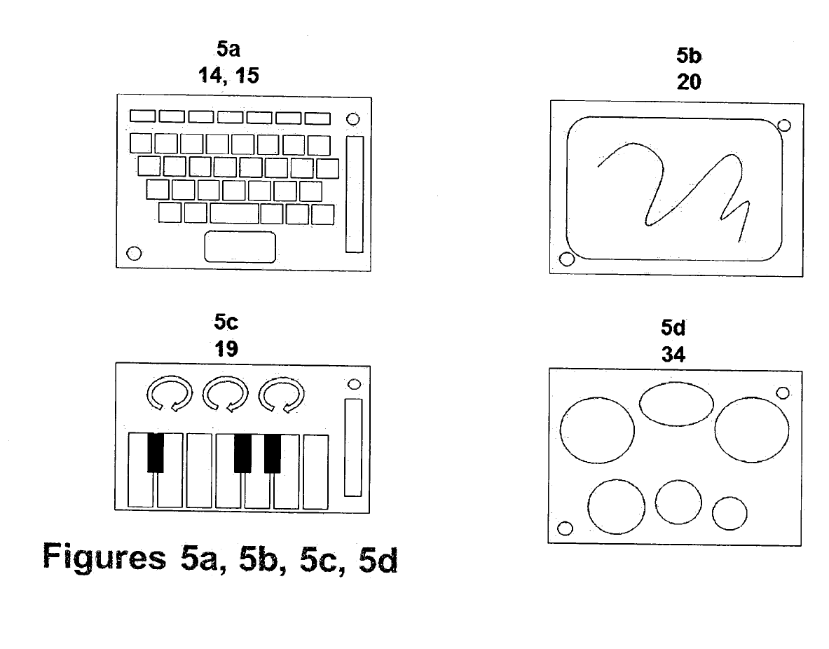

Other applications, for instance as shown in FIGS. 5a, 5b, 5c and 5d, a Computer key board (14) with touch pad & slider (15), a Full drawing area/Touch Screen/Touch surface (20), a Piano key board (19) with dials & slider, and a Drum pad (34), can be implemented according to the invention. For the avoidance of doubt, the present invention is not limited to the above applications.

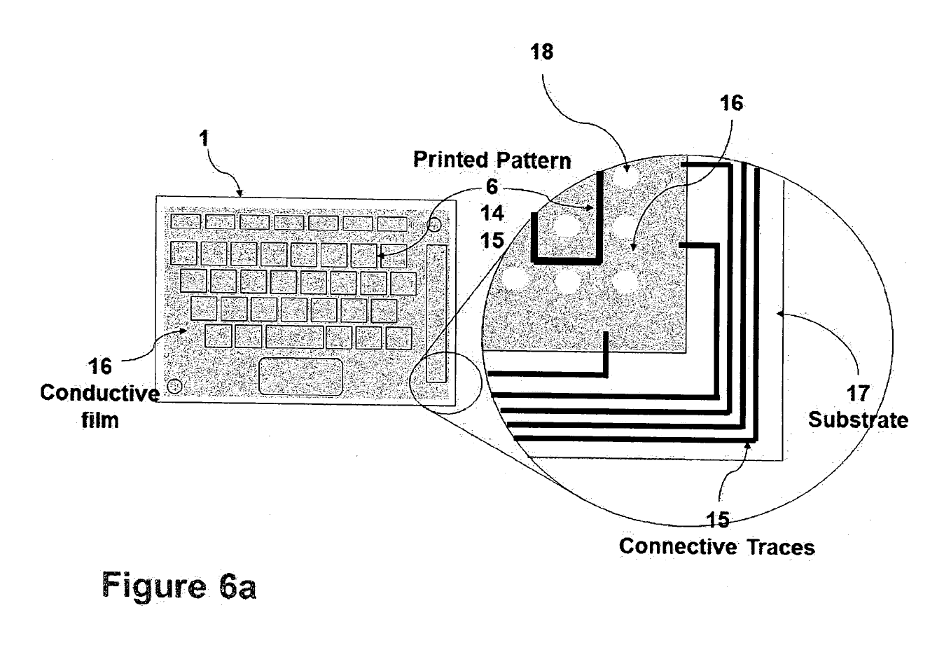

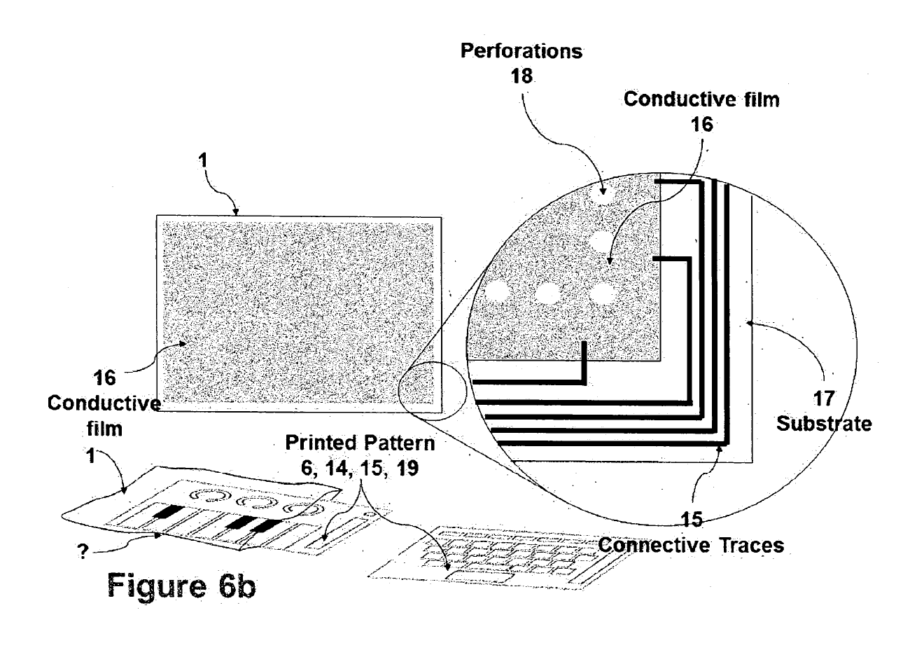

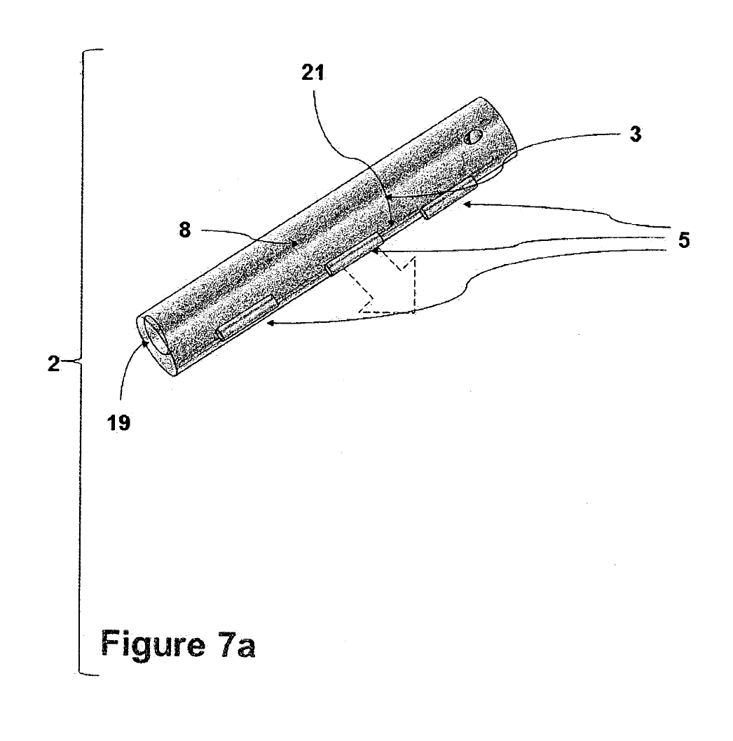

In an embodiment, the touch sensing film is flexible and transparent with appropriate hard coatings, anti-fingerprint coatings and printed patterns as required or desired for the given application. The sensing film can be also semi-transparent or opaque according to the invention. As shown in, for instance, FIGS. 2a, 2d, 3a, 3b, 4, 5 and 9 according to the invention, patterns which indicate the function or information to be transmitted to the computer, can be printed on, in or below the sensor substrate (17) and/or within the touch sensing film (1) stack. Examples of functions and information to be printed include but are not limited to, computer keyboards, e.g. so-called QWERTY keyboards (14) as shown in FIG. 2d, FIG. 3, FIG. 4, FIG. 5a, FIG. 6 and FIG. 9, piano keyboards (19) as shown in FIGS. 5c and 9, drums (34) as shown in FIG. 5d, and/or pointer or drawing areas (20) as shown in FIGS. 3a, 4 and 5b. Other patterns, functions and types of information are also possible according to the invention. For example, as shown in FIGS. 2b, 4 and 5a, a touch sensing film can serve both as a computer keyboard and a touch pad. Moreover, according to the invention, the touch sensing film may have no pattern printed directly on, in or within the touch sensing film. Instead, a printed pattern (6) can be on a separate substrate which can be, for instance, placed above or below the touch sensing film (not shown), or for best alignment, placed in a touch sensing pouch having on one or both sides of the pouch, a touch sensing film (1) (FIG. 6b) or other holding or alignment method as is known in the art. In the case the pattern is below the touch sensing film (1), the touch sensing film (1) should be transparent or semi-transparent.

A modular embodiment of the invention is shown in FIG. 7a where an implementation without the electronics box (4), rolling disks (7) and bearings is illustrated in order to show a rolling axel (19). In this embodiment, the dispensing passage (21) extends fully to one end of the casing (3) to allow the casing (3) to be removed (FIG. 7b). Furthermore, the axel (19) can be further separated in multiple parts as shown in FIG. 7c. Referring to FIG. 7d, an alignment tab (30) is attached to the touch sensing film (1) and it may be used to secure the touch sensing film (1) to the axel and to guide the removable axel module (31) when removing or reinserting it. In this embodiment (FIG. 7d), a Touch processing and Communication Module (10) can be separated from the Touch driving, Sensing and Communication Module (9) which remains attached to the touch sensing film (1). The Touch processing and Communication Module (10) can then be directly attached to the computer/CPU via, for instance, a USB plug which may also supply direct power or charge a battery in the Touch processing and Communication Module (10) and, when in storage or transport, it can be used to charge a battery in the Touch Driving, Sensing and Communication Module (9). The casing (3) may also house, for instance, a projector (23) to display information processed by the CPU via the Touch processing and Communication Module (10). A touch surface (8) can be included also on the casing (3).

A modification of the embodiment of FIG. 7d is shown in FIG. 7e where the detachable axel module (31) also includes the CPU/computer, thus becoming the CPU and Touch processing and Communication Module (25). The module can then be powered or charged via a power/charging connector (24).

A further modification of the embodiments of FIG. 7d and FIG. 7e is shown in FIG. 7f, where the detachable axel module (31) and the casing (3) are combined as a CPU and Touch processing and Communication Module (25) which may also include a display, for instance, by means of a projector (23). The module (25) can then be powered or charged via a power/charging connector (24).

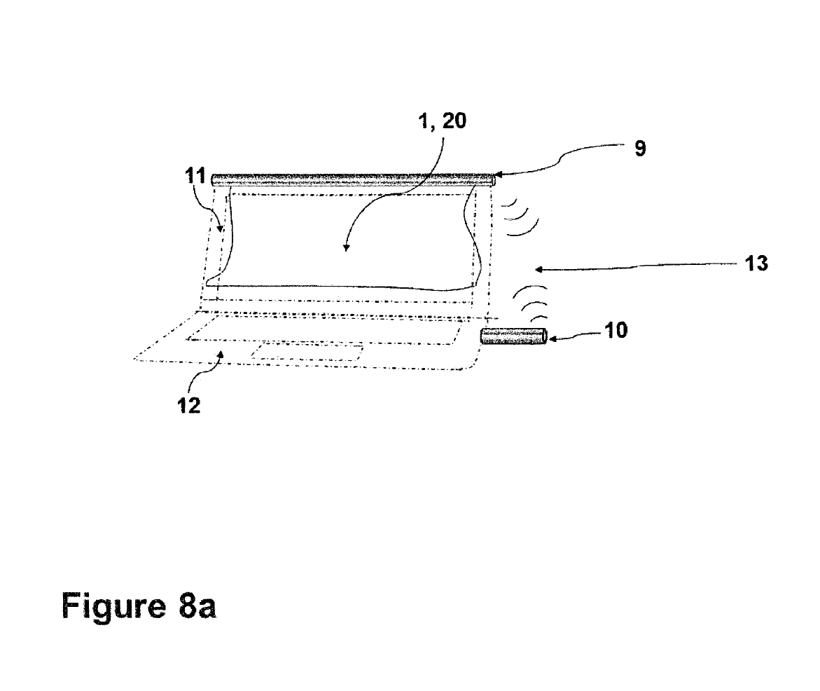

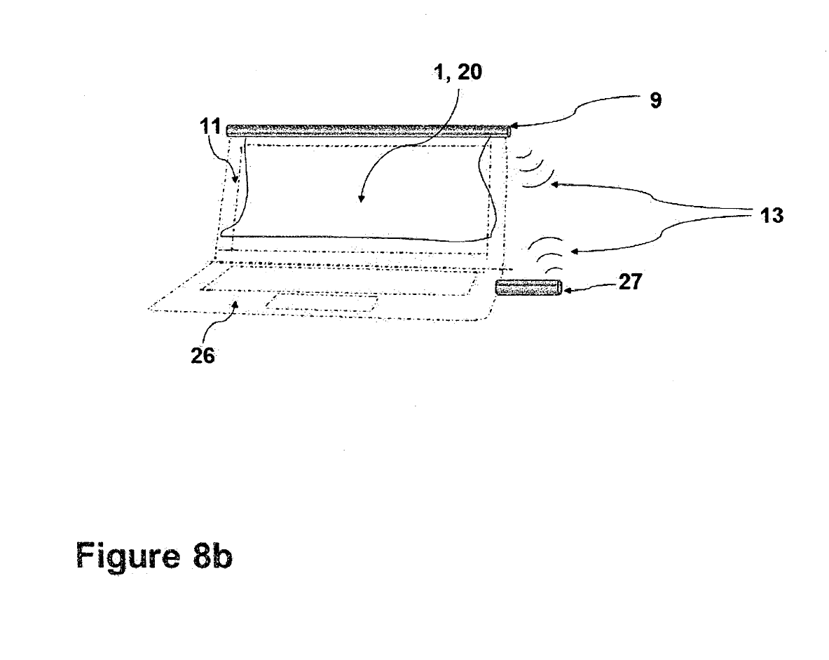

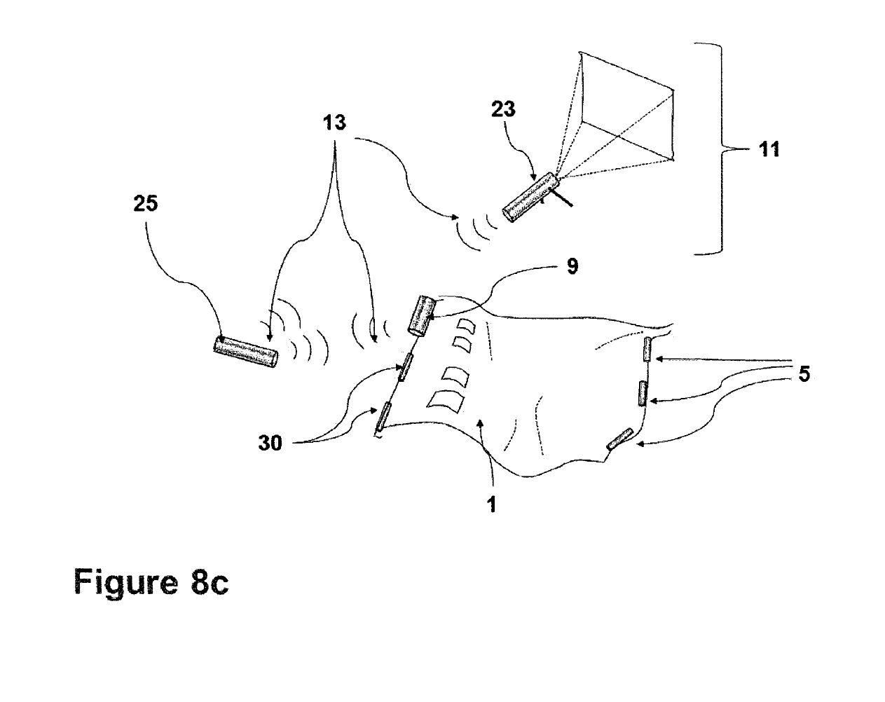

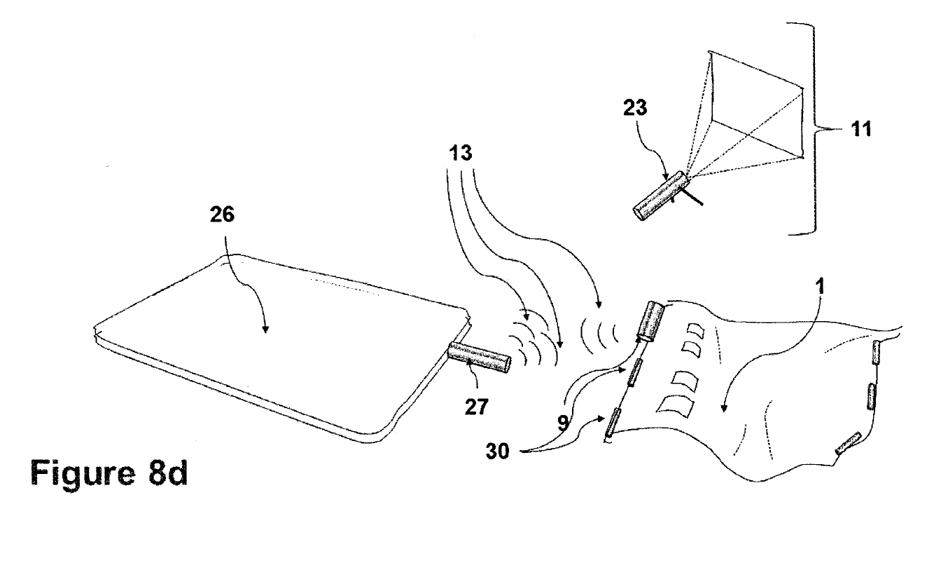

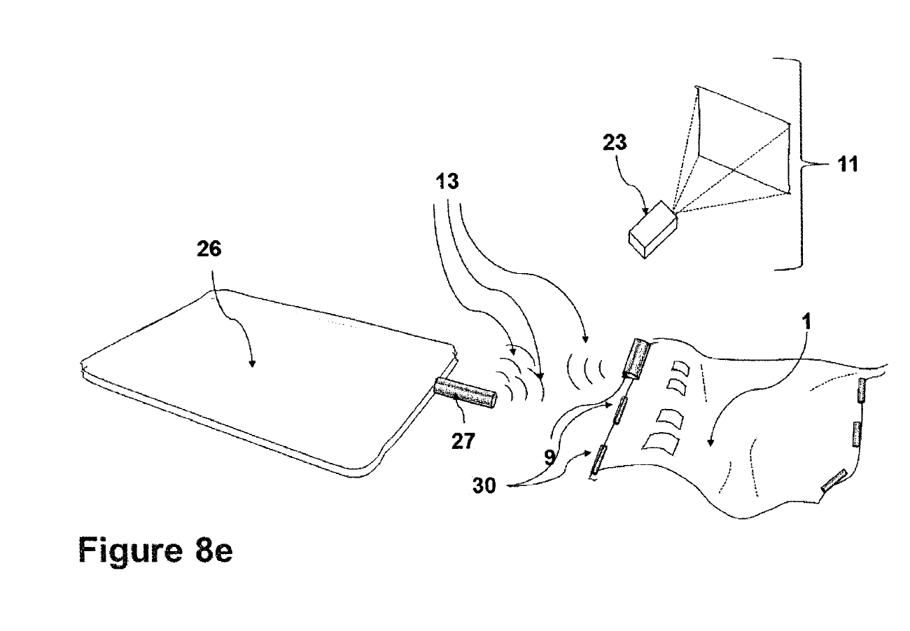

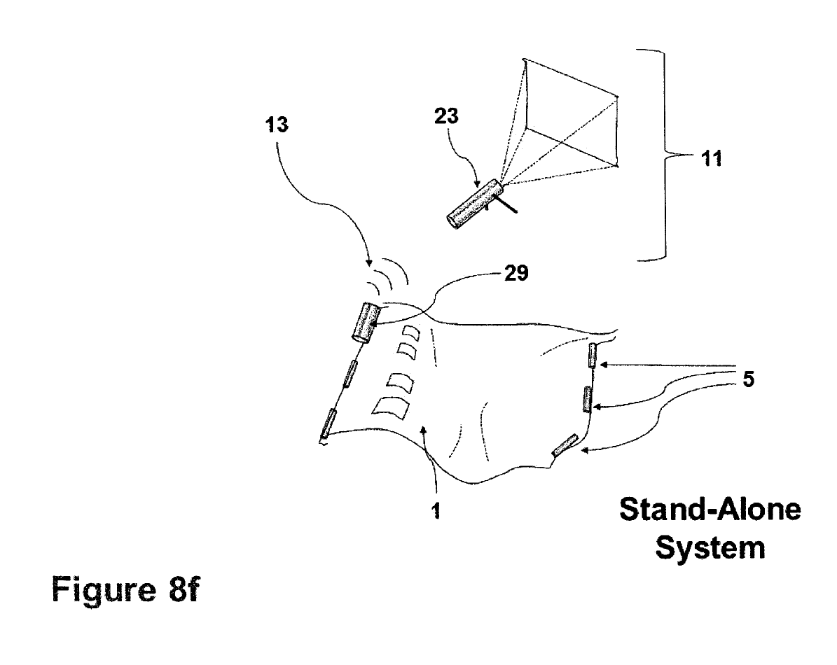

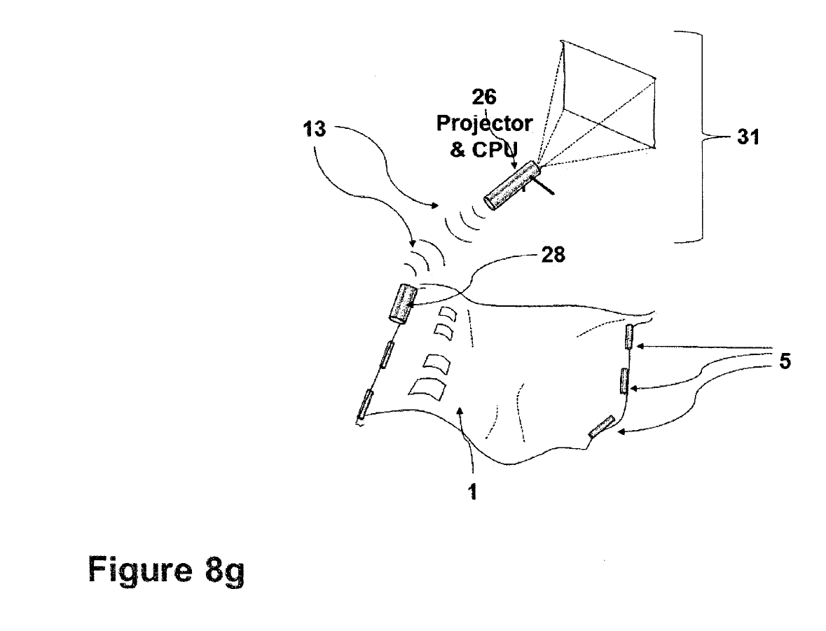

In other words, in FIG. 7a, the device is in its storage/transport mode wherein the touch sensing film (1) is retracted or rolled into the casing (3). In this embodiment, the outer casing (3) can be removed (FIGS. 7b and 7c). The film can be unrolled or extended before or after the cover is removed, however, it is preferable that it is removed after the touch sensing film is unrolled (FIG. 7b). According to this embodiment, the outer casing may contain, for instance, a projector (23) to project an image upon a desired surface, and/or it may contain a computer (a CPU) which is in communication with the touch sensing electronics. Details of each embodiment are described below in connection with FIGS. 8a-8g.

FIG. 8a shows an embodiment of the present invention where the user interface device is used as an add-on touch surface to convert a laptop or notebook computer display (11) into a touch screen. In this particular embodiment, the Touch processing and Communication Module (10) is connected directly to the CPU (12) via a USB connection.

FIG. 8b shows a similar embodiment where the touch processing has been moved to the laptop, thus making it a CPU and Touch Processing Module (26) and then only a communication module (27) is connected via USB connection to the CPU (12).

FIG. 8c shows an embodiment of the present invention where the detachable axel module (31) is further dividable into a CPU and Touch Processing and Communication Module (25) and display module (11) using a projector (23). This module can also be combined with the case (3).

FIG. 8d shows a modification of the embodiment of FIGS. 8b and 8c, wherein a tablet computer or a smartphone is used as the CPU and Touch Processing Module (26).

FIG. 8e shows a modification of the embodiment of FIG. 8d wherein the display (11), such as a projector (23), is not part of the original user interface device (2) but it is a standard off-the-shelf device such as a table-top video projector or a television display.

FIG. 8f shows a stand-alone system where information can be passed (13) wirelessly from the Touch Driving, Sensing and Communication Module (29) after which the information or a consequence of the information, can be displayed via a projector (23) display (11).

FIG. 8g shows a modification of the device of FIG. 8d wherein the CPU is moved to the projector (23) module which may be part of the casing (3) or as part of the detachable axel module (31).

A key feature of the device as exemplified in the examples is that, because the touch sensing film is ultra-thin and flexible, the user input device is full-sized when in use, but it takes only a fraction of its use size when the device is in storage or transport mode.

The touch sensing film can also be textured, embossed, dimpled, formed or otherwise altered such that certain portions are smooth, rough, raised or depressed etc., for providing tactile feedback and easy touch typing properties (not shown). Such physical formations have been already disclosed in patent application U.S. 61/541,414 (“A touch sensitive film”). The film may also incorporate an electronic haptic feedback such as in patent application PCT/FI2011/050197.

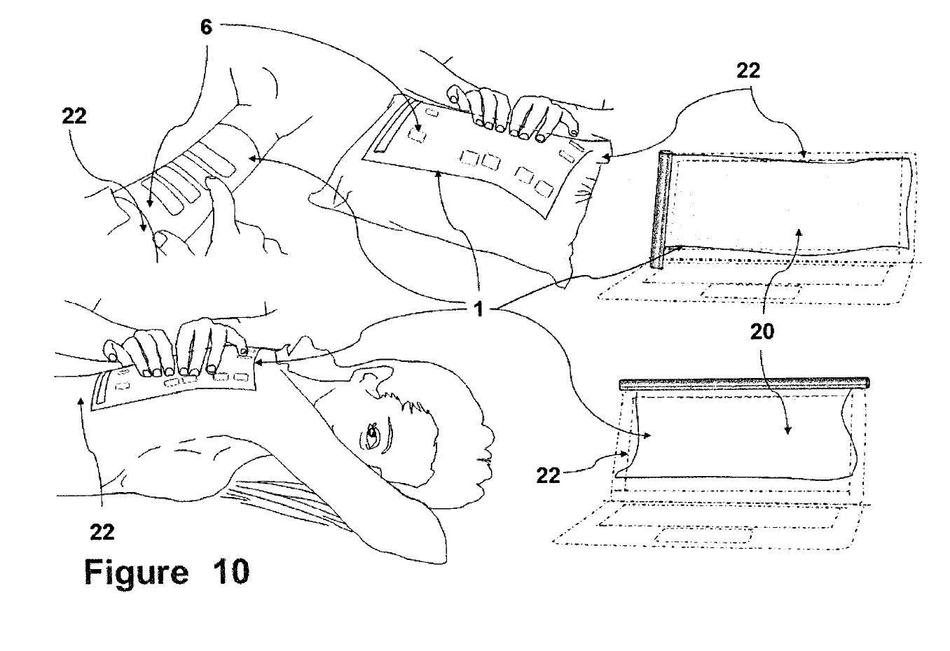

In an embodiment, the flexible nature of the touch sensor allows the user input device to rest and be usable on a wide range of supporting surfaces (22) including hard or soft, flat or curved, moving or stationary as is shown in FIG. 9 and FIG. 10. Examples of supporting surfaces include skin (FIG. 10), pillows (FIG. 10) and furniture (not shown), displays (FIG. 10) and table tops (FIG. 9). The touch sensing film (1) and the case (3) and its associated electronics and mechanics, can be oriented in any direction with respect to each other as is shown in FIG. 10.

In one embodiment of the present invention, the touch sensing film is less than 10 millimeters thick. In another embodiment, the thickness of the touch sensing film is less than 5 millimeters. In another embodiment, the thickness of the touch sensing film is less than 2 millimeters. In another embodiment, the thickness of the touch sensing film is less than 1 millimeters. In another embodiment, the thickness of the touch sensing film is less than 0.5 millimeters. The final one allows the best properties and variability for the touch sensing film in different applications.

In an embodiment of the invention, the ratio of a projected area of the fully extended device to that of the fully rolled or stored device is greater than 2 to 1. In another embodiment of the invention, the corresponding ratio is greater than 4 to 1. In another embodiment of the invention, the corresponding ratio is greater than 6 to 1. In another embodiment of the invention, the corresponding ratio is greater than 8 to 1. In another embodiment of the invention, the corresponding ratio is greater than 10 to 1.

In an embodiment, the ratio of the largest dimension of the fully extended device to that of the fully rolled or stored device is greater than 2 to 1. In another embodiment, the corresponding ratio is greater than 4 to 1. In another embodiment, the corresponding ratio is greater than 6 to 1. In another embodiment, the corresponding ratio is greater than 8 to 1. In another embodiment, the corresponding ratio is greater than 10 to 1.

In an embodiment, the radius of the fully rolled touch sensing film is less than 5 cm. In another embodiment, the corresponding radius is less than 2 cm. In another embodiment, the corresponding radius is less than 1 cm.

In an embodiment, the folding radius of the fully folded touch sensing film is less than 5 cm. In another embodiment, the folding radius is less than 2 cm. In another embodiment, the folding radius is less than 1 cm. In another embodiment, the folding radius is less than 0.5 cm. In another embodiment, the folding radius is less than 0.2 cm.

Certain touch technologies that are compatible with the invention comprise resistive, surface capacitive, projected capacitive and CanaTouch technology (patent application no:s PCT/FI2010/050684, PCT/FI2011/050197 and U.S. 61/541,414) which may allow, for instance, single or multiple locations, relative locations, rotations, speeds, directions, durations, areas and/or pressures to be sensed and interpreted by appropriate electronics.

An alternate embodiment of the invention uses a touch sensing film in the form of a pouch as shown in FIG. 6b. In this embodiment, the touch sensing film does not need to be patterned. Instead, a patterned insert such as a printed sheet of paper, plastic or other appropriate material, is used to define the information to be sensed and transmitted to the computer. In this way, for different applications, the same touch sensing film can be used and only the application software and/or patterned insert need be changed for a new function or application. Such a pattern may be printed by the user as needed.

An alternate embodiment of the invention uses a touch sensing film combined with a flexible or rollable display technology, for instance OLED, transreflective, electrowetting or E-ink (electrophoretic ink) type of display (not shown). In this embodiment, the touch sensing film does not need to be patterned. Instead, the display is used to define the information to be sensed and transmitted to the computer. In this way, for different applications, the same touch sensing film can be used and only the application software and/or displayed pattern need be changed for a new function or application.

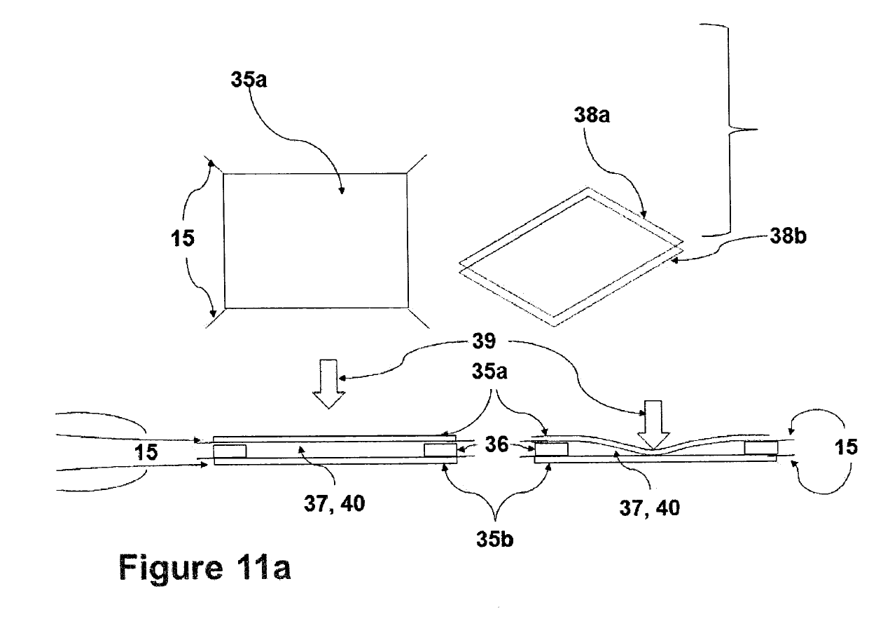

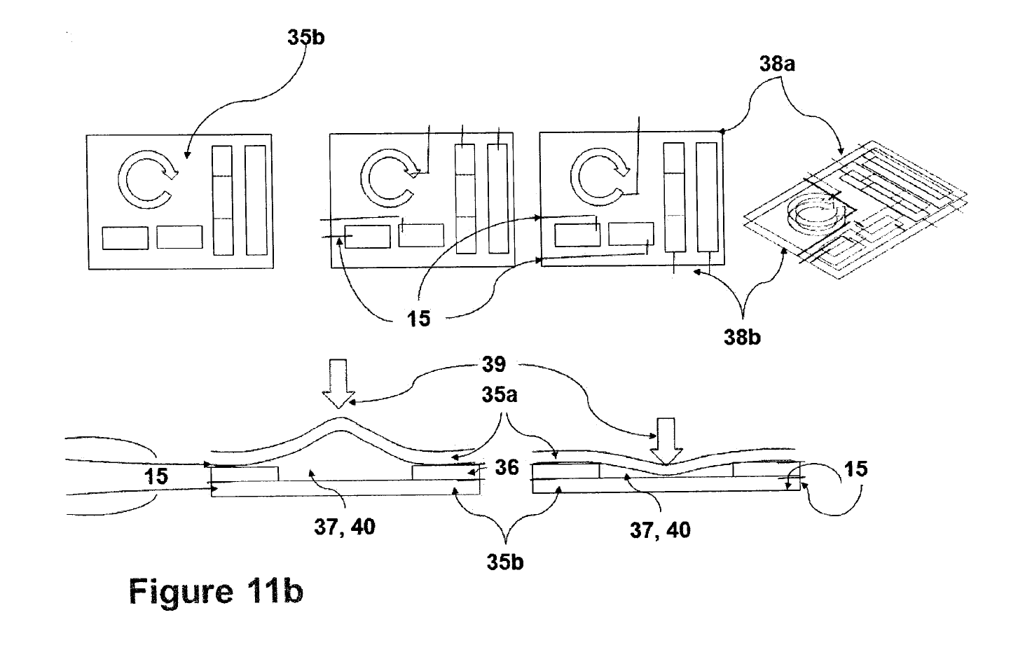

Alternate forms of touch sensors are possible according to the invention, for instance, it has been found that flexibility and high transparency touch sensing is possible with a two-layer resistive touch sensor (35a, 35b) as described in FIG. 11a showing an embodiment for an unsegmented two-layer resistive touch sensor. Here, a dielectric spacer fluid (40), either a pressurized or unpressurized liquid or a pressurized gas such as air, is used to separate the two conductive layers (38a and 38b) of a resistive touch screen (35a, 35b) and so to keep them separate in the case of no touch being present. Pressure is maintained via a seal or gasket (36) around the fluid volume (37). I.e., the separator fluid (40) takes the place of so-called spacer dots used in traditional resistive touch technology. A touch by a touch object (39) closes the circuit and appropriate software and hardware detect the existence or location as in a traditional resistive touch. Spacer fluid (40) as liquid is particularly advantageous as, since it is essentially incompressible, lower pressure or even atmospheric or ambient pressure can be used to fill the fluid volume (37). Moreover, the liquid can be chosen to have the same refractive index of the transparent conductor, substrate or other appropriate material in the touch sensing film so as to minimize reflective losses and maximize electromagnetic radiation (e.g. visible light) transmission through the touch sensing film.

An alternative embodiment is shown in FIG. 11b in which the touch sensing film is constructed in segments such as straight or curved strips or islands such that individual buttons (e.g. on/off, sliders, dials, switches etc.) or groups of buttons are constructed wherein each such button or group of buttons is isolated from the others and has its own set of connector traces (15). One set of connectors leads to the “top” touch sensing film (38a) and another set leads to the “bottom” touch sensing film (38b). A touch by a touch object (39) closes the circuit and appropriate software and hardware detect the existence or location as in a traditional resistive touch. In this embodiment, overall pressure is maintained via a seal or gasket (36) around the total fluid volume (i.e. the sum of individual volumes (37)) and each volume is interconnected via small passages or pressure of each volume (37) is maintained via a seal or gasket (36) around the each separate fluid volume (i.e. the sum of individual volumes (37)).

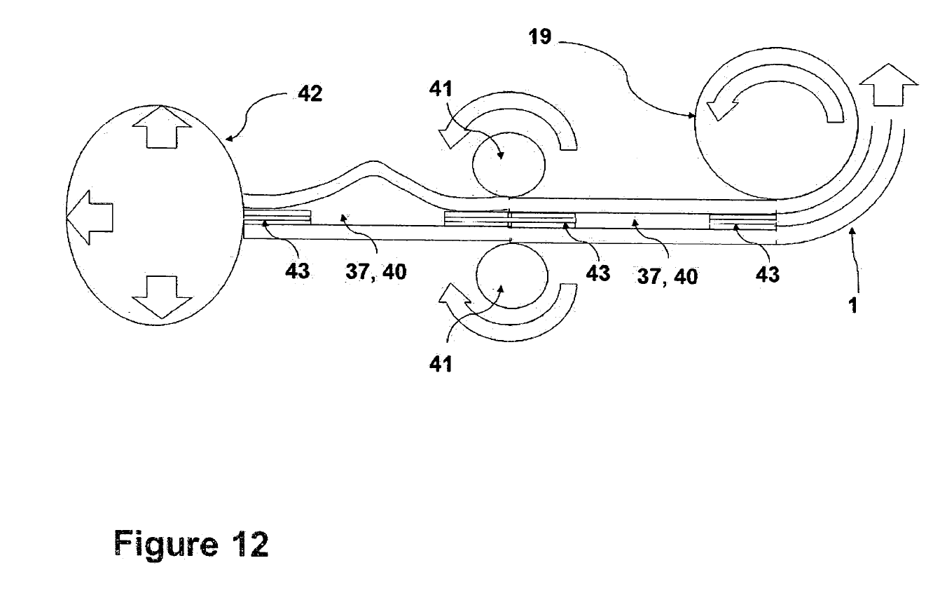

As shown in FIG. 12, according to an embodiment of the invention, a bladder or pouch (42) connected to some or all of the spacer volume(s) within the touch sensing film (1) may be employed to hold excess spacer fluid (40) when the touch sensing film (1) is, for instance, folded, crumpled or rolled for storage around an axel (19). Individual touch volumes (37) can be connected to a common bladder (42) via passages (43) and a nip consisting of a pair of rollers (41) can be used to aid in driving the fluid (40) from the spacer volumes (37) into the bladder (42). The bladder can be used in place of or in addition to the hold tabs (5) (see the hold tabs in FIGS. 2, 5 and 7-9).

Finally, it is to be noted that the conductive film according to the invention need not necessary to be a thin structure which can be called as a film. In an embodiment of the invention, anything that can be used as an active surface in the sensing of touch can be implemented as a touch sensing film (1). These structures may be e.g. printed metal grids or etched metal patterns.

As it is clear to a skilled person, the invention is not limited to the examples described above but the embodiments can freely vary within the scope of the claims.

1. A user interface device, comprising:
a flexible, formable and/or bendable touch sensitive film;
a case into which the touch sensitive film can be stored,
the user interface device comprising necessary electronics, means for sensing touches on or in proximity to the touch sensitive film, power supply and means for outputting information from the user interface device, and thereby outputting information on properties of the touch, wherein the touch sensitive film further comprises at least one printed, textured, embossed, dimpled or other visual or tactile pattern on or in proximity to a substrate,
wherein, when in use as a user interface, the touch sensitive film and/or the substrate uses an external surface as a support.

2. The user interface device according to claim 1, wherein the touch sensitive film can be rolled into the case.

3. The user interface device according to claim 1, wherein the touch sensitive film comprises a High Aspect Ratio Molecular Structure network, a conductive polymer, graphene, a ceramic, grids of metal, or a metal oxide.

4. The user interface device according to claim, further comprising means for generating a haptic feedback via the touch sensitive film in response to the touch.

5. (canceled)

6. The user interface device according to claim 1, further comprising at least one hold tab on an edge of the touch sensitive film configured to facilitate the rolling of the touch sensitive film (1) by both guiding the touch sensitive film into the case and by limiting the rolling of the touch sensitive film.

7. The user interface device according to claim 1, wherein at least a part of the outside surface of the case incorporates a touch surface, allowing user functions to be input.

8. (canceled)

9. The user interface device according to claim 1, wherein as attached to the touch sensitive film, a Touch Driving, Sensing, Processing and Communication Module is configured to determine the touch properties and send the touch properties information to a processing unit.
